(19) United States
(12) Patent Application Publication
(10) Pub. No.: US 2025/0294487 A1
(43) Pub. Date: Sep. 18, 2025

(54) APPARATUS AND METHOD FOR SYNCHRONIZATION OF QUANTUM KEY DISTRIBUTION SYSTEMS

(71) Applicant: FRAUNHOFER-GESELLSCHAFT ZUR FÖRDERUNG DER ANGEWANDTEN FORSCHUNG E.V., München (DE)

(72) Inventors: Jan KRAUSE, Berlin (DE); Nino WALENTA, Berlin (DE)

(21) Appl. No.: 19/223,239

(22) Filed: May 30, 2025

Related U.S. Application Data
(63) Continuation of application No. PCT/EP2022/083939, filed on Nov. 30, 2022.

(51) Int. Cl. H04W 56/00

(52) U.S. Cl. CPC H04W 56/0045

(57) ABSTRACT

An apparatus for synchronization by determining a clock offset between a current receiver clock time and a correct receiver clock time according to an embodiment is provided. The apparatus comprises an input interface for receiving information on a received synchronization sequence comprising a sequence of symbols, wherein the information on the received synchronization sequence comprises information for each symbol of a plurality of symbols of the sequence of symbols that said symbol exhibits a first state out of two or more possible states being different from a second state of the two possible states. Moreover, the apparatus comprises an offset analyser.

### CROSS-REFERENCE TO RELATED APPLICATION

This application is a continuation of copending International Application No. PCT/EP2022/083939, filed Nov. 30, 2022, which is incorporated herein by reference in its entirety.

The present invention relates to synchronization, in particular, to an apparatus and a method for synchronization between a transmitter and a receiver, and, more particularly, to the synchronization of Quantum Key Distribution systems.

### BACKGROUND OF THE INVENTION

Quantum Key Distribution (QKD) denotes a plurality of different quantum cryptography and quantum information concepts, which employ quantum mechanical properties, to provide a (pseudo) random number to two units. Such a (pseudo) random number may, then, for example, be employed as a common symmetric key for symmetric cryptography.

Many Quantum Key Distribution systems operate such that information is transmitted using quantum bits (qubits), for example by using low-power laser pulses or by using single photons for coding. On average, less than one photon per qubit is detected. Afterwards, the receiver has to assign the single photon detections unambiguously to the transmitted qubits. For this purpose, a synchronization between transmitter and receiver with a deviation lower than the transmission duration of a qubit is needed. For example, a qubit may have a temporal length in the order of a nanosecond. A quantum channel uses pulses which are centered in timebins and may, e.g., be used for qubits transmission and sync pattern transmission.

Losses in the quantum channel, limited single photon detection rates and so called dark count rates make such a synchronization more difficult, such that the usual methods that are employed in traditional optical network communications technology cannot be employed.

The synchronization problem can be separated into several partial problems.

On one side, the clocks of the transmitter and of the receiver have to be kept phase-stable at a same frequency.

On the other side, the offset between the clocks of the transmitter and of the receiver has to be identified. For this, a precision is needed which allows a reliable association of the detected single photons to the qubits that have been transmitted by the transmitter.

The standard deviation of this synchronization typically has to exhibit one order smaller than the duration of a qubit. In addition to the above functionality, the synchronization concepts should need as little resources, such as time, random access memory and CPU calculation time, as possible.

Shorter synchronization durations allow faster system start times/higher yields. In addition, they are particularly relevant for multi user scenarios, in which, if needed, systems shall quickly connect and synchronize with each other.

The problem is not limited to QKD systems. In general, the problem relates to the temporal synchronization between two systems, which are connected by a noisy, damping channel with each other. Application fields are, for example, QKD systems, optical satellite communications, deep space communications or LIDAR (Light Detection and Ranging).

In conventional technology, different methods for synchronizing a transmitter and a receiver are employed.

In [1], US 2012/0177200 A1, a GPS-receiver is employed to obtain a time reference.

In [2], US 2017/0230174 A1, traditional signals for synchronization are transmitted in a quantum channel. This needs a variable, optical attenuator. Qubits are transmitted in packets, wherein each qubit packet is embedded into usual information. It appears that in [2] a single synchronization at the beginning is not sufficient.

In [3], WO 2020/254087 A1, a bit-wise synchronization (in units of timebins or qubits) is disclosed. According to this method, the bits are determined sequentially. In practice, such a method may need a lot of time, and synchronization time may, e.g., need one or more minutes.

In [4], Luca Calderaro, Andrea Stanco, Costantino Agnesi, Marco Avesani, Daniele Dequal, Paolo Villoresi, and Giuseppe Vallone, “Fast and Simple Qubit-Based Synchronization for Quantum Key Distribution”, in Phys. Rev. Applied 13, 054041, published 18 Mai 2020, a method is disclosed that employs a two-step cross correlation. The method is described for offsets up to 10⁶ qubits.

### SUMMARY

According to an embodiment, an apparatus for synchronization by determining a clock offset between a current receiver clock time and a correct receiver clock time may have: an input interface for receiving information on a received synchronization sequence comprising a sequence of symbols, wherein the information on the received synchronization sequence comprises information for each symbol of a plurality of symbols of the sequence of symbols that said symbol exhibits a first state out of two or more possible states being different from a second state of the two possible states; and an offset analyser for determining the clock offset by determining an analysis result for each of a plurality of levels depending on the received synchronization sequence and depending on a level pattern being associated with said level, and by determining the clock offset using the analysis result of each of the plurality of levels, wherein the level pattern for each of the plurality of levels comprises a sequence of symbols and is different from any other level pattern of the plurality of levels.

According to another embodiment, an apparatus for generating a synchronization sequence for synchronization, may have: a synchronization sequence generator for generating, using a plurality of level patterns, the synchronization sequence comprising a sequence of symbols, and an output interface for outputting or transmitting the synchronization sequence, wherein the level pattern of each of the plurality of level patterns comprises a sequence of symbols, wherein each of the plurality of symbols of each of the plurality of level patterns exhibits a state out of two or more possible states, wherein the level pattern of each of the plurality of level patterns is different from any other level pattern of the plurality of level pattern, wherein the synchronization sequence generator is configured to generate the synchronization sequence by assigning, to each symbol of the sequence of symbols of the synchronization sequence, the state of one of the plurality of symbols of one of the plurality of level patterns.

According to another embodiment, a system may have: an inventive apparatus for generating a synchronization sequence for synchronization, and an inventive apparatus for synchronization by determining a clock offset, wherein the input interface of the apparatus for synchronization by determining the clock offset is configured to receive the received synchronization sequence, or a part of it, being generated by the apparatus for generating the synchronization sequence, and wherein the offset analyser of the apparatus for synchronization by determining the clock offset is configured to determine the clock offset by determining the analysis result for each of the plurality of levels depending on the received synchronization sequence and depending on the level pattern being associated with said level, and by determining the clock offset using the analysis result of each of the plurality of levels.

According to another embodiment, a method for synchronization by determining a clock offset between a current receiver clock time and a correct receiver clock time may have the steps of: receiving information on a received synchronization sequence comprising a sequence of symbols, wherein the information on the received synchronization sequence comprises information for each symbol of a plurality of symbols of the sequence of symbols that said symbol exhibits a first state out of two or more possible states being different from a second state of the two possible states; and determining the clock offset by determining an analysis result for each of a plurality of levels depending on the received synchronization sequence and depending on a level pattern being associated with said level, and by determining the clock offset using the analysis result of each of the plurality of levels, wherein the level pattern for each of the plurality of levels comprises a sequence of symbols and is different from any other level pattern of the plurality of levels.

According to another embodiment, a method for generating a synchronization sequence for synchronization may have the steps of: generating, using a plurality of level patterns, the synchronization sequence comprising a sequence of symbols, and outputting or transmitting the synchronization sequence, wherein the level pattern of each of the plurality of level patterns comprises a sequence of symbols, wherein each of the plurality of symbols of each of the plurality of level patterns exhibits a state out of two or more possible states, wherein the level pattern of each of the plurality of level patterns is different from any other level pattern of the plurality of level pattern, wherein generating the synchronization sequence comprises assigning, to each symbol of the sequence of symbols of the synchronization sequence, the state of one of the plurality of symbols of one of the plurality of level patterns.

Another embodiment may have a non-transitory digital storage medium having a computer program stored thereon to perform any of the inventive methods when said computer program is run by a computer.

An apparatus for synchronization by determining a clock offset between a current receiver clock time and a correct receiver clock time according to an embodiment is provided. The apparatus comprises an input interface for receiving information on a received synchronization sequence comprising a sequence of symbols, wherein the information on the received synchronization sequence comprises information for each symbol of a plurality of symbols of the sequence of symbols that said symbol exhibits a first state out of two or more possible states being different from a second state of the two possible states. Moreover, the apparatus comprises an offset analyser for determining the clock offset by determining an analysis result for each of a plurality of levels depending on the received synchronization sequence and depending on a level pattern being associated with said level, and by determining the clock offset using the analysis result of each of the plurality of levels. The level pattern for each of the plurality of levels comprises a sequence of symbols and is different from any other level pattern of the plurality of levels.

Moreover, an apparatus for generating a synchronization sequence for synchronization according to an embodiment is provided. The apparatus comprises a synchronization sequence generator for generating, using a plurality of level patterns, the synchronization sequence comprising a sequence of symbols. Moreover, the apparatus comprises an output interface for outputting or transmitting the synchronization sequence. The level pattern of each of the plurality of level patterns comprises a sequence of symbols. Each of the plurality of symbols of each of the plurality of level patterns exhibits a state out of two or more possible states. The level pattern of each of the plurality of level patterns is different from any other level pattern of the plurality of level pattern. The synchronization sequence generator is configured to generate the synchronization sequence by assigning, to each symbol of the sequence of symbols of the synchronization sequence, the state of one of the plurality of symbols of one of the plurality of level patterns.

Furthermore, a method for synchronization by determining a clock offset between a current receiver clock time and a correct receiver clock time according to an embodiment is provided. The method comprises:
Receiving information on a received synchronization sequence comprising a sequence of symbols, wherein the information on the received synchronization sequence comprises information for each symbol of a plurality of symbols of the sequence of symbols that said symbol exhibits a first state out of two or more possible states being different from a second state of the two possible states. And:
Determining the clock offset by determining an analysis result for each of a plurality of levels depending on the received synchronization sequence and depending on a level pattern being associated with said level, and by determining the clock offset using the analysis result of each of the plurality of levels. The level pattern for each of the plurality of levels comprises a sequence of symbols and is different from any other level pattern of the plurality of levels.

Moreover, a method for generating a synchronization sequence for synchronization according to an embodiment is provided. The method comprises:
Generating, using a plurality of level patterns, the synchronization sequence comprising a sequence of symbols. And:
Outputting or transmitting the synchronization sequence.

The level pattern of each of the plurality of level patterns comprises a sequence of symbols. Each of the plurality of symbols of each of the plurality of level patterns exhibits a state out of two or more possible states. The level pattern of each of the plurality of level patterns is different from any other level pattern of the plurality of level pattern. Generating the synchronization sequence comprises assigning, to each symbol of the sequence of symbols of the synchronization sequence, the state of one of the plurality of symbols of one of the plurality of level patterns.

Furthermore, a computer program for implementing one of the above-described methods when being executed on a computer or signal processor according to an embodiment is provided.

For example, the above methods may, e.g., be executed on an FPGA or on an ASIC.

Compared to [1], embodiments need less hardware and reduce the costs and the system complexity.

Compared to [2], embodiments need fewer resources, and the transmission rate in the quantum channel is reduced.

Compared to [3], embodiments avoid to sequentially determine bits and thus avoid to not optimally use the quantum channel. Embodiments realize particularly fast concepts which avoid to employ several communication steps between the transmitter and the receiver. In particular, in contrast to [3], it is not necessary to obtain a confirmation for an identified offset bit from the receiver. This reduces system complexity and accelerates the synchronization.

Compared to [4], it is to be expected that embodiments need few computational resources for large offsets that are to be identified.

### BRIEF DESCRIPTION OF THE DRAWINGS

Embodiments of the present invention will be detailed subsequently referring to the appended drawings, in which:

FIG. 1 illustrates an apparatus for synchronization by determining a clock offset between a current receiver clock time and a correct receiver clock time according to an embodiment.

FIG. 2 illustrates an apparatus for generating a synchronization sequence for synchronization according to an embodiment.

FIG. 3 illustrates a system according to an embodiment.

FIG. 4 illustrates an example of a QKD system. The depicted clock channel is optional and not needed.

FIG. 5 illustrates a relationship between the synchronization pattern and the qubit transmission according to an embodiment.

FIG. 6 illustrates transmitted level patterns according to an embodiment, wherein on a receiver side, only the middle portions of the transmitted level patterns are usable.

FIG. 7 illustrates a generation of a portion of the synchronization pattern from four level patterns according to an embodiment.

FIG. 8A-8C illustrates examples for synchronization according to embodiments.

FIG. 9A illustrates an application of a synchronization method according to an embodiment on the example of FIG. 8C.

FIG. 9B illustrates an application of a synchronization method according to an embodiment for another example, where the receiver's clock is two elements behind.

FIG. 10 illustrates two examples for a maximum receiver's clock offset.

FIG. 11 illustrates a portion of a synchronization pattern according to an embodiment with gₚₐᵣₐₗₗₑₗ=1.

FIG. 12 illustrates a coding of two different pulses according to an example.

FIG. 13 illustrates the structure of three different level patterns according to an embodiment.

FIG. 14 illustrates a comparison of error probabilities with respect to a maximum detectable offset for a scenario for different synchronization concepts of some embodiments with high signal rates (p_{sig}) and low noise rates (pₙₒᵢₛₑ).

FIG. 15 illustrates a comparison of error probabilities with respect to a total pattern duration for a scenario for different synchronization concepts of some embodiments with high signal rates (p_{sig}) and low noise rates (pₙₒᵢₛₑ).

FIG. 16 illustrates a comparison of total pattern durations with respect to a maximum detectable offset for a scenario for different synchronization concepts of embodiments with high signal rates (p_{sig}) and low noise rates (pₙₒᵢₛₑ).

FIG. 17 illustrates a comparison of eoffset reconstruction durations with respect to a maximum detectable offset for a scenario for different synchronization concepts of embodiments with high signal rates (p_{sig}) and low noise rates (pₙₒᵢₛₑ).

FIG. 18 illustrates a comparison of error probabilities with respect to a maximum detectable offset for a scenario for different synchronization concepts of some embodiments with low signal rates (p_{sig}) and high noise rates (pₙₒᵢₛₑ).

FIG. 19 illustrates a comparison of error probabilities with respect to a total pattern duration for a scenario for different synchronization concepts of some embodiments with low signal rates (p_{sig}) and high noise rates (pₙₒᵢₛₑ).

FIG. 20 illustrates a comparison of total pattern durations with respect to a maximum detectable offset for a scenario for different synchronization concepts of some embodiments with low signal rates (p_{sig}) and high noise rates (pₙₒᵢₛₑ).

FIG. 21 illustrates a comparison of offset reconstruction durations with respect to a maximum detectable offset for a scenario for different synchronization concepts of some embodiments with low signal rates (p_{sig}) and high noise rates (pₙₒᵢₛₑ).

### DETAILED DESCRIPTION OF THE INVENTION

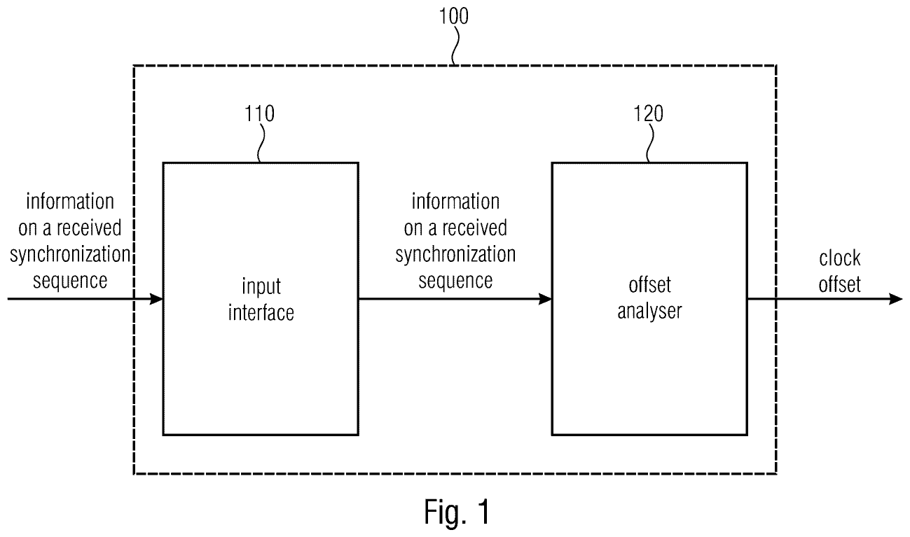

FIG. 1 illustrates an apparatus 100 for synchronization by determining a clock offset between a current receiver clock time and a correct receiver clock time according to an embodiment.

The apparatus 100 comprises an input interface 110 for receiving information on a received synchronization sequence comprising a sequence of symbols, wherein the information on the received synchronization sequence comprises information for each symbol of a plurality of symbols of the sequence of symbols that said symbol exhibits a first state out of two or more possible states being different from a second state of the two possible states.

Moreover, the apparatus 100 comprises an offset analyser 120 for determining the clock offset by determining an analysis result for each of a plurality of levels depending on the received synchronization sequence and depending on a level pattern being associated with said level, and by determining the clock offset using the analysis result of each of the plurality of levels. The level pattern for each of the plurality of levels comprises a sequence of symbols and is different from any other level pattern of the plurality of levels.

When reference is made to a first state out of two or more possible states this may, for example, relate to a first bit value out of two bit values. However, other embodiments may, e.g., relate to non-binary sequences, for example, ternary sequences.

A clock offset between a current receiver clock time and a correct receiver clock time is determined. If said clock offset is determined, the current receiver clock time can be corrected using the clock offset to obtain the correct receiver clock time. For example, the clock offset may, e.g., be added to, or may, e.g., be subtracted from the current receiver clock time to obtain the correct receiver clock time.

According to an embodiment, synchronization may, e.g., be conducted such that the index of every symbol received by the receiver can correctly be identified by the receiver.

In particular, in an embodiment, what is synchronized is the offset between the transmitter clock and the receiver clock plus the transmission time of the optical pulses from the transmitter to the receiver. Therefore, the synchronization conducted may, e.g., be referred to as index offset synchronization.

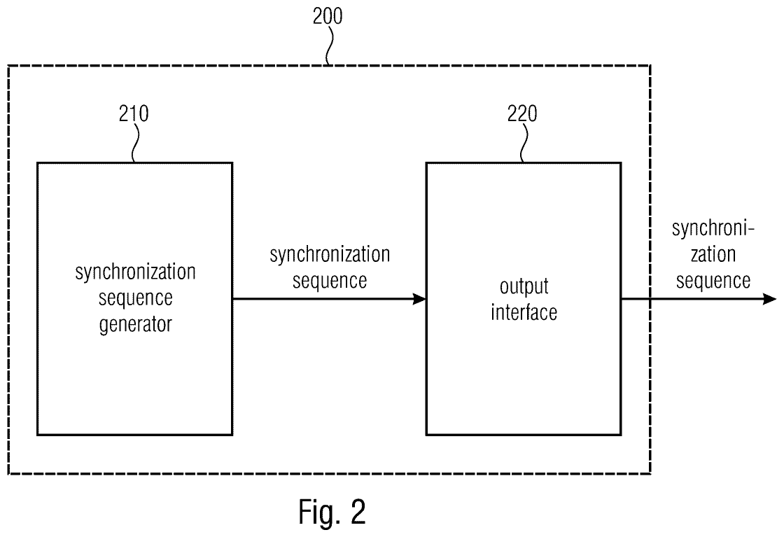

According to an embodiment, the input interface 110 may, e.g., be configured to receive the received synchronization sequence from another apparatus 200 (e.g., the apparatus 200 of FIG. 2), wherein, for the synchronization, the apparatus 100 may, e.g., be configured to not transmit any message to said other apparatus 200.

In an embodiment, each symbol of the sequence of symbols of the synchronization sequence may, e.g., be randomly or pseudo-randomly associated with a level out of the plurality of levels such that the state of said symbol of the sequence of symbols corresponds to a state of a symbol of the level pattern being associated with said level.

According to an embodiment, the synchronization sequence that may, e.g., be received as the received synchronization sequence has been generated such that the synchronization sequence comprises symbols of the level pattern of each level of the plurality of levels, wherein each symbol of the symbols of said level pattern may, e.g., be encoded by the state of one or more symbols of the sequence of symbols of the synchronization sequence. The synchronization sequence has been generated such that for each symbol position in the synchronization sequence, the level pattern of one of the plurality of levels has been chosen for determining a symbol for said symbol position in the synchronization sequence, such that the symbols of different level patterns are mixed within the synchronization sequence, such that the synchronization sequence does not comprise the symbols of a level pattern of one of the plurality of levels in a correct order. In other words, the symbols of different level pattern may, e.g., be interleaved within the synchronization sequence.

In an embodiment, a first one of the symbols of the synchronization sequence may, e.g., exhibit a state that corresponds to the state of a symbol of the level pattern being associated with a first level out of the plurality of levels. A second one of the symbols of the synchronization sequence, which immediately succeeds the first one of the symbols within the synchronization sequence, may, e.g., exhibit a state that corresponds to the state of a symbol of the level pattern being associated with a second level out of the plurality of levels, the second level being different from the first level. A third one of the symbols of the synchronization sequence, which immediately succeeds the second one of the symbols within the synchronization sequence, may, e.g., exhibit a state that corresponds to the state of a symbol of the level pattern being associated with a third level out of the plurality of levels, the third level being different from the second level.

According to an embodiment, the synchronization sequence that may, e.g., be received as the received synchronization sequence has been generated such that it comprises one or more occurrences of the level pattern of each level of the plurality of levels in a correct order.

In an embodiment, the offset analyser 120 may, e.g., be configured to determine the analysis result for each level [symbol] of the plurality of levels by determining for said level, whether or not the offset exhibits at least [symbol] ⁻¹ time units, wherein a time unit is equal to a duration of a symbol of the sequence of symbols, or is equal to a positive multiple m of the duration of a symbol of the sequence of symbols, wherein the level [symbol] is an integer value with [symbol] ≥0 for each of the plurality of levels, wherein m is a real value with m>0. For example, the multiple m may, e.g., be m>1. Or, for example, the multiple m may, e.g., be 0<m<1.

For example, depending on the coding, it may, e.g., be needed to also transmit the level with [symbol] =0. In particular, regarding early-late coding (binary pulse position modulation), transmitting the level with [symbol] =0 may, e.g., be employed to correctly find the raster on which the symbols are encoded. In contrast, if, for example, polarization coding is employed, transmitting the level with [symbol] =0 is not necessary.

However according to an embodiment, if the offset is greater than or equal to [symbol] ^{max-1}, then [symbol] ^{max} is to be subtracted from the offset.

According to an embodiment, the offset analyser 120 may, e.g., be configured to determine a level offset for each level [symbol] of the plurality of levels, such that the level offset for said level [symbol] may, e.g., be either [symbol] ⁻¹ time units or may, e.g., be 0; wherein the level [symbol] may, e.g., be an integer value with [symbol] ≥0 for each of the plurality of levels. The clock offset may, e.g., correspond to a sum of the level offset of each level [symbol] of the plurality of levels, or may, e.g., correspond to a difference of the sum and [symbol] ^{max}, or may, e.g., correspond to an integer multiple of said sum or of said difference, or may, e.g., correspond to said sum or of said difference divided by a predefined value.

In an embodiment, the reconstructed offset may, e.g., be the sum of all level offsets, but only if said sum is smaller than [symbol] ^{max-1}. Otherwise, [symbol] ^{max} is to be subtracted from the offset.

In an embodiment, the offset analyser 120 may, e.g., be configured to determine for each level of the plurality of levels and a comparison result for each symbol of at least a portion of the plurality of symbols, which exhibits the first state, whether a symbol at a corresponding position in the level pattern of the said level exhibits the first state or exhibits the second state. The offset analyser 120 may, e.g., be configured to determine the level offset such that the level offset may, e.g., be 0, if for said level more comparison results have been determined where the compared symbols exhibit a same state compared to comparison results for said level where the compared symbols exhibit a different state. Moreover, the offset analyser 120 may, e.g., be configured to determine the level offset such that the level offset may, e.g., exhibit [symbol] ⁻¹ time units, if for said level more comparison results or a same number of comparison results have been determined where the compared symbols exhibit a different state compared to comparison results for said level where the compared symbols exhibit the same state.

According to an embodiment, the level offset for each level may, e.g., be determined subsequently starting from a smallest level among the plurality of levels.

In an embodiment, if the offset analyser 120 has determined for a level of the plurality of levels that a level offset exhibits [symbol] ⁻¹ time units, the plurality of symbols of the received synchronization sequence may, e.g., be shifted by the level offset for said level before determining the level offset for a subsequent level of the plurality of levels.

FIG. 2 illustrates an apparatus 200 for generating a synchronization sequence for synchronization according to an embodiment.

The apparatus 200 comprises a synchronization sequence generator 210 for generating, using a plurality of level patterns, the synchronization sequence comprising a sequence of symbols.

Moreover, the apparatus 200 comprises an output interface 220 for outputting or transmitting the synchronization sequence.

The level pattern of each of the plurality of level patterns comprises a sequence of symbols. Each of the plurality of symbols of each of the plurality of level patterns exhibits a state out of two or more possible states. The level pattern of each of the plurality of level patterns is different from any other level pattern of the plurality of level pattern.

The synchronization sequence generator 210 is configured to generate the synchronization sequence by assigning, to each symbol of the sequence of symbols of the synchronization sequence, the state of one of the plurality of symbols of one of the plurality of level patterns.

According to an embodiment, the apparatus 200 is configured to transmit the synchronization sequence to a further apparatus 100 (e.g., the apparatus 100 of FIG. 1), wherein, for the synchronization, the apparatus 200 is configured to not receive any message from said further apparatus 100.

In an embodiment, the synchronization sequence generator 210 may, e.g., be configured to select, for each symbol of the sequence of symbols of the synchronization sequence, a level out of the plurality of levels. Moreover, the synchronization sequence generator 210 may, e.g., be configured to assign a symbol of the plurality of symbols of the level pattern associated with said level to said symbol of the sequence of symbols of the synchronization sequence.

In an embodiment, the synchronization sequence generator 210 may, e.g., be configured to select, for each symbol of the sequence of symbols of the synchronization sequence, the level out of the plurality of levels, randomly or pseudo-randomly. By this, the symbols of different level pattern may, e.g., be interleaved within the synchronization sequence.

According to an embodiment, the synchronization sequence generator 210 may, e.g., be configured to generate the synchronization sequence such that the synchronization sequence comprises symbols of the level pattern of each level of the plurality of levels. Moreover, the synchronization sequence generator (210) is configured to generate the synchronization sequence such that for each symbol position in the synchronization sequence, the level pattern of one of the plurality of levels is chosen for determining a symbol for said symbol position in the synchronization sequence, such that the symbols of different level patterns are mixed within the synchronization sequence, such that the synchronization sequence does not comprise the symbols of a level pattern of one of the plurality of levels in a correct order.

According to an embodiment, each level out of the plurality of levels may, e.g., belong to a group out of one or more groups, e.g., out of two or more groups. The synchronization sequence generator 210 may, e.g., be configured to select, for a symbol of the sequence of symbols of the synchronization sequence, a level out of a current group out of the one or more groups, e.g., out of the two or more groups or more groups. Moreover, the synchronization sequence generator 210 may, e.g., be configured to assign a symbol of the plurality of symbols of the level pattern associated with said level to said symbol of the sequence of symbols of the synchronization sequence.

In an embodiment, the synchronization sequence generator 210 may, e.g., be configured to generate the synchronization sequence such that it comprises one or more occurrences of the level pattern of each level of the plurality of levels in a correct order.

In an embodiment, the level pattern of each level comprises a sequence of symbols. Each symbol of the plurality of symbols of the level pattern of each level either exhibits a first bit value out of two possible bit values or a second bit value out of the two possible bit values. Each of the plurality of symbols of said level pattern may, e.g., be encoded by a state of one or more symbols of the plurality of symbols of the level pattern. The synchronization sequence comprises a sequence of symbols, wherein each of the sequence of symbols of the synchronization sequence may, e.g., be encoded by a state of one or more symbols of the sequence of symbols of the synchronization sequence. The synchronization sequence generator 210 may, e.g., be configured to generate the sequence of symbols of the synchronization sequence by assigning one of the plurality of symbols of the level pattern of a level as a symbol of the synchronization sequence for each of the sequence of symbols of the synchronization sequence.

According to an embodiment, the level pattern for each level [symbol] of the plurality of levels may, e.g., comprise a first sequence of c× [symbol] -1 symbols which may, e.g., exhibit the first bit value, immediately followed by a second sequence of symbols which may, e.g., exhibit the second bit value; or wherein the level pattern for each level [symbol] of the plurality of levels may, e.g., comprise the second sequence of c× [symbol] ⁻¹ symbols which may, e.g., exhibit the second bit value, immediately followed by the first sequence of c× [symbol] ⁻¹ symbols which may, e.g., exhibit the first bit value, wherein c is a real positive value such that c× [symbol] ⁻¹∈ [symbol] .

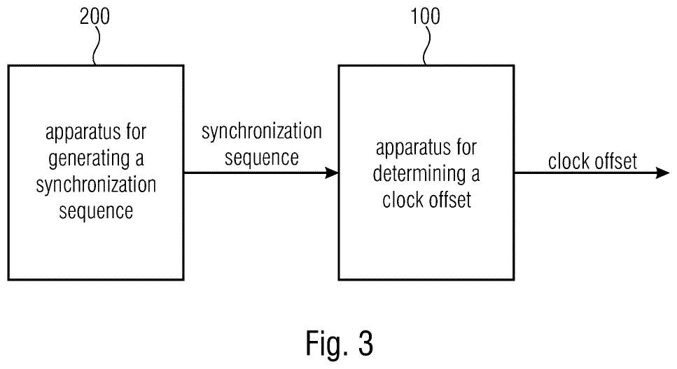

FIG. 3 illustrates a system according to an embodiment.

The system comprises an apparatus 200 for generating a synchronization sequence.

Moreover, the system comprises an apparatus 100 for determining a clock offset.

The input interface 110 of the apparatus 100 for determining the clock offset is configured to receive information on the received synchronization sequence, or a part of it, being generated by the apparatus 200 for generating the synchronization sequence. For example, due to channel losses only a fraction of the symbols arrives at the receiver, but embodiments of the present invention nonetheless allow synchronization.

The offset analyser 120 of the apparatus 100 for determining the clock offset is configured to determine the clock offset by determining the analysis result for each of the plurality of levels depending on the received synchronization sequence and depending on the level pattern being associated with said level, and by determining the clock offset using the analysis result of each of the plurality of levels.

According to an embodiment, the system may, e.g., comprise one or more further apparatuses of FIG. 1 for synchronization by determining a clock offset. The input interface 110 of each of the further apparatuses for synchronization by determining the clock offset may, e.g., be configured to receive the received synchronization sequence being generated by the apparatus 200 for generating the synchronization sequence. The offset analyser 120 of each of the further apparatuses for synchronization by determining the clock offset is configured to determine the clock offset by determining the analysis result for each of the plurality of levels depending on the received synchronization sequence and depending on the level pattern being associated with said level, and by determining the clock offset using the analysis result of each of the plurality of levels.

For example, according to such a multi-user scenario, the transmitter connects with a plurality of receivers. The optical fibre may, e.g., then be split, such that each of the receivers may, e.g., receive the synchronization pattern at the same time. Each of the receivers may, e.g., then conduct synchronization.

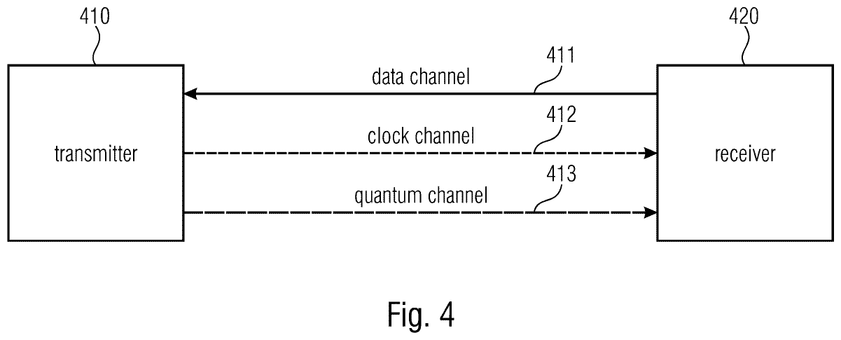

Before describing embodiments of the present invention in more detail, at first, an example for a QKD system is described. Such an example for a QKD system is illustrated by FIG. 4.

In FIG. 4, three communication channels 411, 412, 413 are established between a transmitter 410 and a receiver 420. The depicted clock channel 412 is optional and not needed.

A (classical) data channel 411 allows a bidirectional exchange of data. The requirements for this channel 411 are low in that regard that it does not have to fulfil particular requirements regarding latency. In addition, for this channel 411, the latency may be unknown, temporally variable and direction dependent. Only an upper limit ΔTₘₐₓ for the maximum transmission time difference of two signals sent at the same time from the transmitter via the data channel 411 and via a quantum channel 413 should be known. Such a maximum transmission time difference may well be up to several seconds. Such an approach is useful, as it significantly reduces the requirements for the data channel 411. Routing via paths or channels (e.g., TCP/IP) being different from the quantum channel is thus possible. The classical data channel 411 has unknown but limited, high latency (e.g. some milliseconds) which may, e.g., corresponds to millions of transmitted timebins in a quantum channel 413.

A (classical) clock channel 412 may, e.g., be employed for stabilizing the frequency and phase difference of the clocks of the transmitter 410 and of the receiver 420. The clock of the transmitter 410 may, e.g., define the system time. The clock of the receiver 420 shall be kept frequency and phase stable with respect to the transmitter clock. This may, e.g., be achieved by transmitting a simple on/off signal via the clock channel 412. Additionally, a clock offset between a current receiver clock time and a correct receiver clock time has to be determined. If said clock offset is determined, the current receiver clock time can be corrected using the clock offset to obtain the correct receiver clock time. For example, the clock offset may, e.g., be added to, or may, e.g., be subtracted from the current receiver clock time to obtain the correct receiver clock time.

In principle, the clock channel 412 is not necessary, for example, if the clocks of the transmitter 410 and of the receiver are stable enough to allow a reconstruction of frequency and phase from the single photon detections of the quantum channel 413.

In general, the classical clock channel 412 only transmits periodic clock pulses, and is only used to remove clock drifts. In the following, classical clock channel 412 and clock drifts may, e.g., be ignored. Some embodiments are implemented without a classical clock channel 412, as this clock channel 412 is not necessary for the synchronization concepts of the present invention.

For example, an object may, e.g., be to identify a clock offset between a current receiver clock time and a correct receiver clock time with timebin precision. For a given pair p_{sig} (signal detection probability) and pₙₒᵢₛₑ (noise detection probability) the error probability should be close to 0. A clock offset between a current receiver clock time and a correct receiver clock time may, e.g., be determined. If said clock offset is determined, the current receiver clock time can be corrected using the clock offset to obtain the correct receiver clock time.

In the following, particular embodiments of the invention are described.

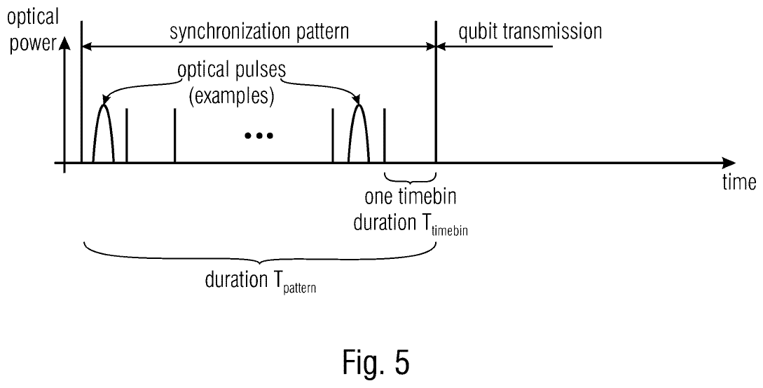

FIG. 5 illustrates a relationship between optical pulses and a synchronization pattern according to an embodiment.

According to some embodiments, it may, e.g., be assumed that the transmitter 410 and the receiver 420 have agreed and will agree, or that the transmitter 410 informs the receiver 420 (for example, by an indication in the start signal from the transmitter 410 to the receiver 420 over the data channel) on the synchronization concept that is employed. (E.g., [symbol] ₘₐₓ, gₚₐᵣₐₗₗₑₗ).

In other embodiments, the transmitter 410 and the receiver 420 use the same synchronization concept, and no communication/indication which synchronization concept is employed is needed.

In an embodiment, the synchronization protocol may, e.g., be employed as follows, wherein it may, for example, be assumed that the transmitter and the receiver assume a same duration of a timebin:

The transmitter 410 and the receiver 420 agree on an upper limit ΔTₘₐₓ being a maximum transmission time difference between the data channel 411 and the quantum channel 413, and agree on a degree of parallelization gₚₐᵣₐₗₗₑₗ∈ [symbol] .

Based on the procedure described below, the transmitter 410 and the receiver 420 calculate a length of the synchronization pattern.

E.g., using a start signal, the transmitter 410 informs the receiver 420 via the data channel 411 on the beginning of the synchronization. About the same time, the transmitter 410 starts transmitting the synchronization pattern via the quantum channel. The generation of a synchronization pattern according to an embodiment is described below.

Directly after receiving the start signal, the receiver 420 may, e.g., set its clock to zero and starts recording single photon detection time stamps according to its clock. At least from this point-in-time on, the clock of the receiver 420 should be phase stable with respect to the clock of the transmitter 410.

Subsequently to the transmission of the synchronization pattern, the transmitter 410 starts, e.g., immediately, with the transmission of the qubits. In particular, at no point in time, any confirmation of the receiver is needed.

After the time Tₚₐₜₜₑᵣₙ has passed according to the clock of the receiver 420, the receiver 420 starts to analyze the single photon detection time tags received until then, to determine therefrom the needed correction of its clock. About the same time, the receiver 420 stores all further incoming single photon detection time tags.

After the end of the time-offset analysis, the receiver 420 corrects all its remaining time stamps and all its afterwards received time stamps.

In the following, the above-described steps are described for a particular embodiment in more detail, wherein one or more of the following steps may, e.g., be employed individually or in combination with each other.

At first a determination of Tₘₐₓ according to an embodiment is described.

According to one embodiment, Tₘₐₓ may, e.g., be predefined, and may, e.g., be available at the transmitter 410 and at the receiver 420. E.g., Tₘₐₓ may, e.g., be programmed in program code of the transmitter 410 and of the receiver 420, and/or may, e.g., be stored in a memory of the transmitter 410 and in a memory of the receiver 420. Such an approach is sufficient for most cases and has an advantage to result in short synchronization times.

Several approaches exist to optimally determine the smallest possible value for Tₘₐₓ. One approach according to an embodiment comprises determining, in a first step, the duration that a signal needs to travel from unit 1 (e.g., the transmitter 410, for example, referred to as “Alice”) to unit 2 (e.g., the receiver 420, for example, referred to as “Bob”) and back from unit to unit 1 via the (classic) data channel 411.

In the following, a calculation of a length of the synchronization pattern according to an embodiment is described.

The length of the synchronization pattern from Tₘₐₓ may, e.g., be calculated as follows: At first, a maximum synchronization level [symbol] max may, e.g., be determined, such that the following calculation rule certain ΔTₘₐₓ are sufficiently large.

$$Δ {T}_{max} = {T}_{symbol} \times {N}_{max}^{( s )}$$

$${N}_{max}^{( s )} = {2}^{{ℓ}_{max} - 1} - 1$$

The duration of a synchronization pattern Tₚₐₜₜₑᵣₙ may, e.g., then result as:

$${T}_{pattern} = {T}_{symbol} \times {N}_{pattern}^{( s )} ,$$

wherein the number of symbols Nₚₐₜₜₑᵣₙ^{(s)} of the complete pattern may, e.g., be:

$${N}_{pattern}^{( s )} = {g}_{amount} \times {N}_{level}^{( s )} ,$$

wherein the number of pattern groupsgₐₘₒᵤₙₜ being:

gₐₘₒᵤₙₜ=┌ [symbol] ₘₐₓ+α_{enc}/gₚₐᵣₐₗₗₑₗ┐.

where α_{enc} depends on the encoding of the symbols and is 1 for encoding in two or more timebins and 0 for different encodings, e.g. polarization encoding, and wherein the number of symbols per level Nₗₑᵥₑₗ^{(s)} (or per group N_{group}^{(s)}) being:

$${N}_{level}^{( s )} = {N}_{group}^{( s )} = {c}_{2} {2}^{{ℓ}_{max} + 1} ,$$

where c₂≥1 is a positive real number, such that c₂ [symbol] ^{max+1}∈ [symbol] , that can be used to prolong the pattern, e.g. to increase the detection statistics.

It should be noted that if ΔTₘₐₓ would have been selected too small, the detection statistics may, e.g., be insufficient to obtain a correct result. This problem may, e.g., be avoided by selecting [symbol] max sufficiently large, or by choosing c₂>1, as mentioned above.

In the following, synchronization patterns according to embodiments are described.

The offset of the clocks of the transmitter 410 and of the receiver 420 may, e.g., be represented as a binary number in a binary representation. The synchronization pattern may, e.g., comprise a plurality of levels, wherein each level of the plurality of levels is used by the receiver 420 for determining that bit of the binary number, that is associated with said level.

The pattern for a level may, e.g., be described using the symbols s∈{0,1}.

i may, e.g., indicate a symbol index within the pattern [symbol] for level [symbol] . The symbol index may, e.g., be represented in binary representation as:

$$i = … {i}_{2} {i}_{1} {i}_{0} , mit {i}_{n} ∈ \{ 0 , 1 \}$$

Further, the symbol index i₋₁ may, e.g., be defined as i₋₁=0.

According to an embodiment, the pattern for level [symbol] with [symbol] ∈{0, . . . , [symbol] ₘₐₓ} may, e.g., then be defined by the function:

$${P}_{ℓ} ( i ) = {i}_{ℓ - 1} , mit i ∈ \{ 0 , 1 , … , {2}^{{ℓ}_{max} + 1} - 1 \}$$

For [symbol] ₘₐₓ=2 the following level patterns are obtained:

| Level [symbol] | Level pattern [symbol] |
|---|---|
| 0 | 0, 0, 0, 0, 0, 0, 0, 0 |
| 1 | 0, 1, 0, 1, 0, 1, 0, 1 |
| 2 | 0, 0, 1, 1, 0, 0, 1, 1 |

According to a particular embodiment, the level pattern for the level [symbol] =0 comprises a number of [symbol] ^{max+1} zeros (0). For each level, [symbol] >0 a subpattern is generated comprising a number of [symbol] ⁻¹ zeros (0), followed by number of [symbol] ⁻¹ ones (1) and the subpattern for the level [symbol] is repeated to obtain the pattern for the level [symbol] such that the pattern for the level [symbol] comprises [symbol] ^{max+1} bits.

According to such an embodiment, for [symbol] ₘₐₓ=2 the level patterns illustrated above are obtained.

Moreover, in to such an embodiment, for [symbol] ₘₐₓ=1 the following level patterns are obtained:

| Level [symbol] | Level pattern [symbol] |
|---|---|
| 0 | 0, 0, 0, 0 |
| 1 | 0, 1, 0, 1 |

Furthermore, in to such an embodiment, for [symbol] ₘₐₓ=3 the following level patterns are obtained:

| Level [symbol] | Level pattern [symbol] |
|---|---|
| 0 | 0, 0, 0, 0, 0, 0, 0, 0, 0, 0, 0, 0, 0, 0, 0, 0 |
| 1 | 0, 1, 0, 1, 0, 1, 0, 1, 0, 1, 0, 1, 0, 1, 0, 1 |
| 2 | 0, 0, 1, 1, 0, 0, 1, 1, 0, 0, 1, 1, 0, 0, 1, 1 |
| 3 | 0, 0, 0, 0, 1, 1, 1, 1, 0, 0, 0, 0, 1, 1, 1, 1 |

In an alternative particular embodiment, the level pattern for the level [symbol] =0 may, e.g., comprise a number of [symbol] ^{max+1} ones (1).

According to an alternative embodiment, for each level, [symbol] >0 a subpattern is generated comprising a number of [symbol] ⁻¹ ones (1), followed by number of [symbol] ⁻¹ zeros (0) and the subpattern for the level [symbol] is repeated to obtain the pattern for the level [symbol] such that the pattern for the level [symbol] comprises [symbol] ^{max+1} bits.

In an embodiment, the complete synchronization pattern is now formed by transmitting quasi “at the same time” within a group. In such an embodiment, for each symbol that is to be transmitted one of the levels of that group and the corresponding symbol value of the level pattern of the selected level is transmitted. Said symbol value is the symbol value of the corresponding symbol of the (complete) synchronization pattern.

According to a particular embodiment, for example, for each symbol, the level is selected (pseudo)randomly.

The receiver does not have to know which level the transmitter did select for selecting the symbol value to be transmitted.

For example, as already outlined, each level pattern comprises Nₗₑᵥₑₗ^{(s)}=N_{group}^{(s)}=c₂ [symbol] max⁺¹ symbols. For determining a k-th symbol value of a transmission, one of the levels may, e.g., be selected, for example, (pseudo)randomly, and from the level pattern of the selected level, the (k mod c₂ [symbol] ^{max+1})-th symbol value of said level pattern may, e.g., be transmitted from the transmitter 410 to the receiver 420 (mod denotes modulo). By this selection, the symbols of different level pattern may, e.g., be interleaved within the synchronization sequence.

For example, determining from the level patterns of [symbol] ₘₐₓ=2 a synchronization pattern of 8 symbols, when the following levels are selected for each of the symbols, the following synchronization pattern (sync.pattern) results.

For the 8 symbols:

| Level [symbol] | Level pattern [symbol] |
|---|---|
| 0 | 0, 0, 0, 0, 0, 0, 0, 0 |
| 1 | 0, 1, 0, 1, 0, 1, 0, 1 |
| 2 | 0, 0, 1, 1, 0, 0, 1, 1 |
| Selected [symbol] | 2, 1, 0, 0, 2, 1, 0, 1 |
| Sync. pattern | 0, 1, 0, 0, 0, 1, 0, 1 |

Alternatively, determining a k-th symbol value of a transmission, one of the levels may, e.g., be selected, for example, (pseudo)randomly, and from the level pattern of the selected level, the ((k+c) mod [symbol] ^{max}^{⁺¹})-th symbol value of said level pattern may, e.g., be selected, with c being an integer with 0<c< [symbol] ^{max}^{⁺¹}.

According to an embodiment, within each group, gₚₐᵣₐₗₗₑₗ bits of the offset may, e.g., be determined. gₚₐᵣₐₗₗₑₗ may, e.g., be determined depending on a channel quality such that gₚₐᵣₐₗₗₑₗ is small enough to ensure a reliable functioning of the concept, but such that the total duration Tₚₐₜₜₑᵣₙ of the pattern is as short as possible.

In an embodiment, with a parallelization degree of gₚₐᵣₐₗₗₑₗ=2, each group receives two levels. For example, the first group may, e.g., then receive levels 0 and 1 and the second group may, e.g., then receive level 2 and 3, etc.

In another embodiment, with a parallelization degree of gₚₐᵣₐₗₗₑₗ=2, and with [symbol] ₘₐₓ=2 (levels 0, 1, 2), the first group may, e.g., then receive levels 0 and 1, and the second group may, e.g., then receive level 2, only. Or, in another embodiment, the second group may, e.g., choose randomly between level 2 and symbol 0.

According to embodiments, for coding the symbols, one of several concepts may, e.g., be applied, such as:

Pulse position coding with, e.g., two timebins, wherein 0 may, e.g., be coded by an early pulse, and 1 may, e.g., be coded by a late pulse. This would need the use of the aforementioned level 0.

Polarization coding, wherein 0 may, e.g., be coded by a horizontal polarization, and wherein 1 may, e.g., be coded by a vertical polarization.

Differential phase coding with two timebins, wherein 0 may, e.g., be coded with phase ϕ=0 with respect to the previous pulse, and wherein 1 may, e.g., be coded with phase ϕ=π with respect to the previous pulse. This would need the use of the aforementioned level 0.

In other embodiments, other coding concepts may, e.g., be employed.

For example, considering pulse position coding, wherein 0 may, e.g., be coded by an early pulse, and 1 may, e.g., be coded by a late pulse, with [symbol] ₘₐₓ=2 the level patterns may, e.g., be encoded as follows:

| Level [symbol] | Level pattern [symbol] | | | | | | | | | | | | | | | |
|---|---|---|---|---|---|---|---|---|---|---|---|---|---|---|---|---|
| 0 | 0 | | 0 | | 0 | | 0 | | 0 | | 0 | | 0 | | 0 | |
| Encoding of [symbol] 0 | P | - | P | - | P | - | P | - | P | - | P | - | P | - | P | - |
| 1 | 0 | | 1 | | 0 | | 1 | | 0 | | 1 | | 0 | | 1 | |
| Encoding of [symbol] 1 | P | - | - | P | P | - | - | P | P | - | - | P | P | - | - | P |
| 2 | 0 | | 0 | | 1 | | 1 | | 0 | | 0 | | 1 | | 1 | |
| Encoding of [symbol] 2 | P | - | P | - | - | P | - | P | P | - | P | - | - | P | - | P |

(P indicates the presence of a pulse, while - indicates the absence of a pulse.)

(P indicates the presence of a pulse, while-indicates the absence of a pulse.)

In the following, the analysis at the receiver 420 is considered.

At first cross-correlation synchronization and the analysis at the receiver side is described.

| Timebin index | 0 | 1 | 2 | 3 | 4 | 5 | 6 | 7 |
|---|---|---|---|---|---|---|---|---|
| Symbol index | 0 | | 1 | | 2 | | 3 | |
| Symbol value | 0 | | 1 | | 1 | | 0 | |
| Early-late coding | 1 | 0 | 0 | 1 | 0 | 1 | 1 | 0 |

Cross-correlation synchronization is conceptually easy, easy to implement, but computationally expensive, as it, in a simple version, has N², and, using Fast Fourier Transform, has N log N complexity.

On the receiver side, it works as follows. The received pulses are considered, and it is analyzed, whether or not, at positions of received pulses, a pulse shall really be present according to the synchronization pattern. If this is not the case, a shift of the received pulse sequence may, e.g., be conducted, and the analysis is repeated. This process is continued until the shifted received pulse sequence matches or at least sufficiently matches with the synchronization pattern:

In the table below, the transmitted synchronization pattern corresponds to the synchronization pattern that the receiver 420 expects to receive. However, in the table below, the synchronization pattern has been received asynchronously and is thus shifted:

| Timebin index | 0 | 1 | 2 | 3 | 4 | 5 | 6 | 7 |
|---|---|---|---|---|---|---|---|---|
| Transmitted | 1 | 0 | 0 | 1 | 0 | 1 | 1 | 0 |
| Received | 0 | 1 | 0 | 0 | 1 | 0 | 1 | 1 |
| Comparison at pulses | | − | | | − | | + | − |

(− corresponds to no match; + corresponds to match)

Summing the minuses as −1 and the pluses as +1 and dividing then by the number of received pulses results in: Contrast=(−2)/4=−0.5.

A contrast result significantly smaller than one may, e.g., be interpreted that the received pulse sequence has to be shifted.

A shift by 0.5 symbols (1 timebin) to the right results in:

| Timebin index | 0 | 1 | 2 | 3 | 4 | 5 | 6 | 7 |
|---|---|---|---|---|---|---|---|---|
| Transmitted | 1 | 0 | 0 | 1 | 0 | 1 | 1 | 0 |
| Received, shifted | 1 | 0 | 1 | 0 | 0 | 1 | 0 | 1 |
| Comparison at pulses | + | | − | | | + | | − |

Contrast: 0/4 = 0.

A shift by 0.5 symbols (1 timebin) of the received pulse sequence to the left results in:

| Timebin index | 0 | 1 | 2 | 3 | 4 | 5 | 6 | 7 |
|---|---|---|---|---|---|---|---|---|
| Transmitted | 1 | 0 | 0 | 1 | 0 | 1 | 1 | 0 |
| Received, shifted | 1 | 0 | 0 | 1 | 0 | 1 | 1 | 0 |
| Comparison at pulses | + | | | + | | + | + | |

Contrast: 4/4 = 1.

As the contrast is sufficiently close to one, it may, e.g., be assumed the correct shift has been found.

In the following, the method with gₚₐᵣₐₗₗₑₗ=1 according to an embodiment is described with particular focus on the receiver side analysis.

The method with gₚₐᵣₐₗₗₑₗ=1 is based on the idea that a correct offset is a number that can be represented as a binary number.

In the method with gₚₐᵣₐₗₗₑₗ=1, the level patterns are transmitted such that each of the level patterns is repeatedly transmitted (e.g., four times); afterwards the level pattern of the subsequent level is repeatedly transmitted, etc.

For example, an offset of 1 symbol (2 timebins) may, e.g., be represented as a binary representation:

2₁₀=010₂

wherein the leftmost bit is associated with level 2, wherein the middle bit is associated with level 1 and wherein the rightmost level is associated with level 0.

Moreover, some embodiments are based on the finding that corrections can be done subsequently. For example, consider that an offset of 3.5 symbols (7 timebins) exists, e.g.:

The clock (and the received synchronization pattern) may, e.g., now be corrected by 3.5 symbols (7 timebins). Alternatively, it is also possible to correct the clock and the received synchronization pattern (e.g., starting from the least significant bit) by 0.5 symbols (1 timebin), then by 1 symbol (2 timebins) and then by 2 symbols (4 timebins).

According to an embodiment, the level patterns are considered subsequently, starting with the level pattern for level 0.

If the level pattern corresponds to the level pattern for a considered level, the numeral that corresponds to said level in the offset is set to 0, as no correction is needed for said level.

If the level pattern does not correspond to the level pattern for a considered level, the numeral that corresponds to said level in the offset is set to 1, as a correction is needed for said level. Moreover, the received synchronization pattern is immediately corrected for all subsequent levels by shifting the bits of said level by the number of symbols [symbol] ⁻¹ (by the number timebins [symbol] ) that corresponds to said level. Then, the analysis is continued for the next level.

For early-late coding, the symbol values and pulses for the level patterns 0, 1 and 2 are depicted below.

Moreover, assuming an offset of a right shift of 1 symbol (2 timebins)

2₁₀=010₂

the pulses received on the receiver side and a comparison at the pulses are also shown:

Level pattern and pulses for level 1:

| Timebin index | 0 | 1 | 2 | 3 | 4 | 5 | 6 | 7 |
|---|---|---|---|---|---|---|---|---|
| Symbol index | 0 | | 1 | | 2 | | 3 | |
| Symbol value | 0 | | 0 | | 0 | | 0 | |
| Transmitted pulses | 1 | 0 | 1 | 0 | 1 | 0 | 1 | 0 |
| Received pulses | 1 | 0 | 1 | 0 | 1 | 0 | 1 | 0 |
| Comparison | + | | + | | + | | + | |

Contrast: 4/4 = 1 => Level 0 is correct => Assume value 0 for level 0.

Level pattern and pulses for level 1:

| Timebin index | 0 | 1 | 2 | 3 | 4 | 5 | 6 | 7 |
|---|---|---|---|---|---|---|---|---|
| Symbol index | 1 | | 1 | | 2 | | 3 | |
| Symbol value | 0 | | 1 | | 0 | | 1 | |
| Transmitted pulses | 1 | 0 | 0 | 1 | 1 | 0 | 0 | 1 |
| Received pulses | 0 | 1 | 1 | 0 | 0 | 1 | 1 | 0 |
| Comparison | | − | − | | | − | − | |

Contrast: −4/4 = −1 => Level 1 is incorrect => Assume value 1 for level 1.

Correcting the offset for level 1 results in a left shift of the received synchronization sequence by 2 timebins (1 symbol). The right shift by 1 symbol (2 timebins) that exists in the received synchronization pattern is thus undone and a comparison of the corrected received synchronization pattern with the level pattern for level 2 results in:

Level pattern and pulses for level 2:

| Timebin index | 0 | 1 | 2 | 3 | 4 | 5 | 6 | 7 |
|---|---|---|---|---|---|---|---|---|
| Symbol index | 1 | | 1 | | 2 | | 3 | |
| Symbol value | 0 | | 0 | | 1 | | 1 | |
| Transmitted pulses | 1 | 0 | 1 | 0 | 0 | 1 | 0 | 1 |
| Received pulses | 1 | 0 | 1 | 0 | 0 | 1 | 0 | 1 |
| Comparison | + | | + | | | + | | + |

Contrast: 4/4 = 1 => Level 2 is correct => Assume value 0 for level 2.

For the method with gₚₐᵣₐₗₗₑₗ=1, the for each level, one after the other, the level pattern for said level is repeatedly transmitted, e.g., four times, and then repeated transmission of the level pattern for the next level continues.

Benefits of the method with gₚₐᵣₐₗₗₑₗ=1 are that it is computationally efficient, and should exhibits a complexity of N log N, but with favorable coefficients, compared to cross-correlation synchronization. Moreover, it exhibits a low memory usage and is easy to implement. However, when the level patterns are sent sequentially, it needs a long transmission.

For example, assuming that the maximum offset can be 100 ms and the timebin duration is 800 ps, then 27 levels would be needed. Each of the levels may, e.g., be transmitted for a duration of 4Δtₘₐₓ. For 27 levels, this results in 10.8 seconds.

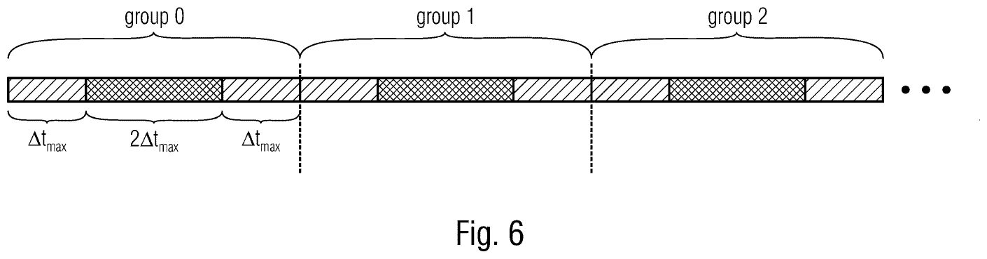

FIG. 6 illustrates a transmission of the level patterns for synchronization with gₚₐᵣₐₗₗₑₗ=1 according to an embodiment. On a receiver side, only the middle portions of the transmitted level patterns are usable.

The synchronization method with flexible gₚₐᵣₐₗₗₑₗ presents an improved idea, wherein multiple levels are transmitted (quasi) simultaneously (interleaved).

At each symbol, it is decided, e.g., randomly, from which level to pick the symbol value. This can reduce a transmission duration by a factor of e.g. 30.

Afterwards a comparison between (a portion of) the received synchronization sequence and the level pattern takes place. Comparing a level pattern for one of the levels with (a portion of) the synchronization sequence will result in the following:

For those pulses of the synchronization sequence that are associated with a symbol of another level, the comparison of those pulses with the level pattern for the considered level will cause a random result, and thus the comparison will be either −1 (pulses do not match) or 1 (pulses match). For a larger number of pulses, however, it can be expected that the average value of these comparisons will be 0 (roughly about 50% no matches and roughly about 50% matches).

If an offset does not exist for a level, for those pulses of the synchronization sequence that are associated with a symbol of the considered level, the comparison of those pulses with the level pattern for the considered level will be 1 (if noise is neglected). In that case, it can be expected that the average of the comparison of all received pulses with the level pattern of the considered level will be significantly greater than zero (as the expectation value for all random comparisons is 0).

However, if an offset does exist for a level, for those pulses of the synchronization sequence that are associated with a symbol of the considered level, the comparison of those pulses with the level pattern for the considered level will be −1. In that case, it can be expected that the average of the comparison of all received pulses with the level pattern of the considered level will be significantly smaller than zero (as the expectation value for all random comparisons is 0). In that case, the correction of the received synchronization sequence may, e.g., immediately be corrected for the considered level. E.g., if an offset is detected in level 2, the received synchronization sequence is (e.g., left) shifted by 22=4 timebins.

As a further remark, for the case of a quantum channel 413, it can be assumed that a lot of pulses are lost during transmission so that they can no longer be detected at the receiver 420. Nonetheless, the synchronization concepts according to embodiments work well, as only those timebins may, e.g., be considered for which pulses have been detected. Those timebins, where no pulses have been detected may, e.g., be ignored in the analysis and do not increase the resource usage (RAM).

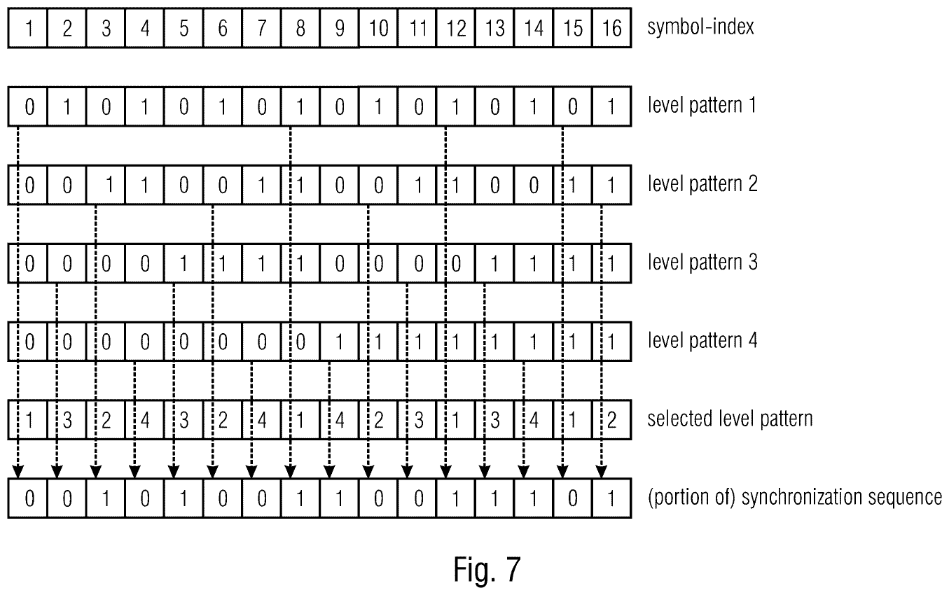

FIG. 7 illustrates a generation of a portion of the synchronization pattern from four level patterns according to an embodiment.

In FIG. 7, four level patterns are depicted, namely level patterns 1, 2, 3 and 4. The four level patterns depict the symbol values for each of 16 symbol indices.

For example, a synchronization sequence generator 210 selects for each of the symbol indices one of the level patterns. Such a selection may, e.g., be conducted randomly or pseudo-randomly. The selection is depicted in the line “selected level pattern”. In said line, the level number of the selected level pattern is depicted.

The resulting portion of the synchronization sequence is depicted in the last line of FIG. 7.

In the following, further embodiments and considerations are provided.

After the QKD system starts, the transmitter and the receiver have clocks with arbitrary offset. Due to insufficient precision, they cannot update their times via an NTP server. GPS is also no option, since sufficient signal strength in a building is not guaranteed. Neither of them would account for the propagation delay of the quantum signals through the quantum channel.

Thus, a best option for coarse synchronization is over the classical channel. The classical channel might be routed over different fibers and multiple routers with unknown and variable delay/latency compared to the quantum channel.

Therefore, as one option, the transmitter sends a sync message, coarsely marking to over the classical channel. Thus, the transmitter and the receiver have their clocks synchronized with a maximum offset ±Δtₘₐₓ that depends on the link distance and additional latencies (e.g., unknown routing, encryption and decryption, IP packet processing).

Furthermore, according to an embodiment, a “synchronization channel” guarantees that the transmitter's and the receiver's clock keep a constant offset.

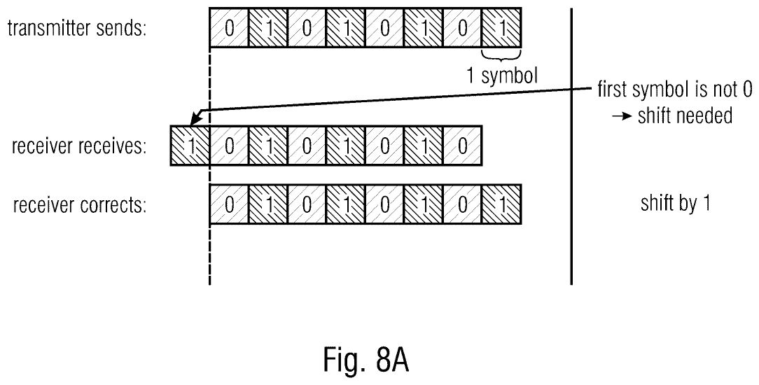

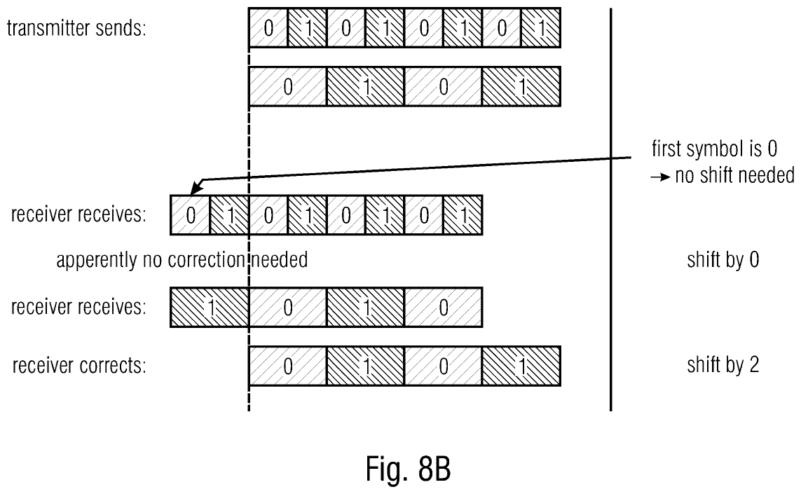

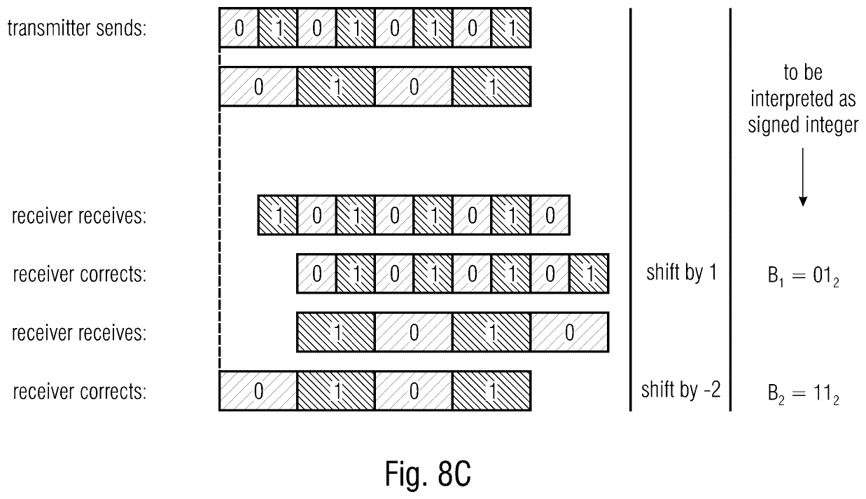

FIG. 8A illustrates an example for synchronization according to an embodiment. Depicted is a synchronization sequence comprising a sequence of symbols, wherein the symbol values exhibit either a first value (a first state, L) or a second value (a second state, R). In the example of FIG. 8A, a shift by one symbol on the receiver side is needed.

FIG. 8B illustrates an example for synchronization according to another embodiment, where it is assumed that the receiver's clock is two elements behind, what shall be corrected on the receiver side.

FIG. 8C illustrates an example for synchronization according to a further embodiment, where it is assumed that the receiver's clock is one element ahead, what shall be corrected on the receiver side.

From the above, it can be seen that to detect an offset within +2ⁿ elements, 2ⁿ⁺¹ synchronization levels may, e.g., be employed.

A last level may, e.g., be employed to detect corrections into the wrong direction. Thus, in case of a deviation in the last level, one may, e.g., shift in the opposite direction.

Returning to the example of FIG. 8Cc, there, the receiver's clock is ahead by A=1=01₂ elements. Embodiments should yield a total shift of B=−1=11₂ elements (2 bit cover ±1 elements clock offset). Thus, the values B₁ and B₂ in FIG. 8C may, e.g., be interpreted as a signed integer.

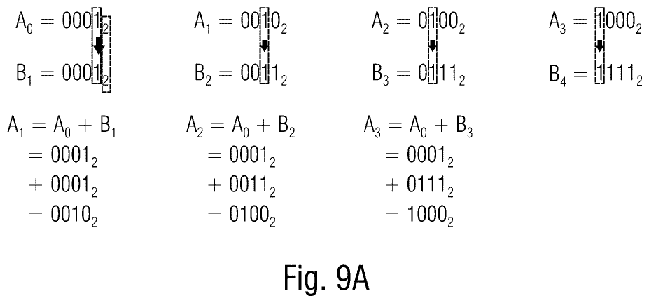

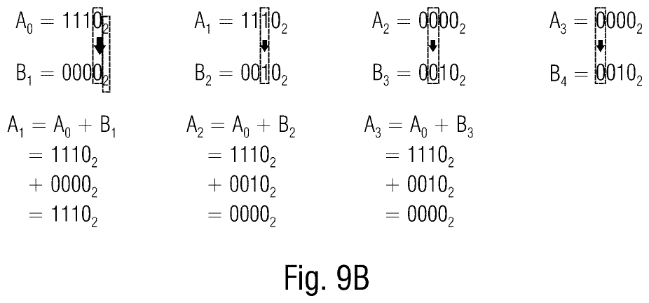

FIG. 9A illustrates an application of a synchronization method according to an embodiment on the example of FIG. 8C. In the example of FIG. 8C, the receiver's clock is ahead by A₀=1=0001₂ elements (to be interpreted as a signed integer). Thus, a method according to an embodiment should yield a total shift of B₄=−1=1111₂ elements, to be applied by the receiver. As initially, the shift that the receiver should apply to his clock is unknown B₀ is set to B₀=0000₂. The example according to an embodiment that yields B₄=1111₂ is depicted in FIG. 9A.

FIG. 9B illustrates an application of a synchronization method according to an embodiment for another example, where the receiver's clock is two elements behind. In particular, the receiver's clock is behind by A₀=−2=1110₂ elements (to be interpreted as signed integer). The synchronization method of an embodiment should yield a total shift of B₄=+2=0010₂ elements, to be applied by the receiver. Again, as initially, the shift that the receiver should apply to his clock is unknown B₀ is set to B₀=0000₂. The example according to an embodiment that yields B₄=0010₂ is depicted in FIG. 9B.

As further aspects, it should be considered that for the example of a quantum channel, there is a low detection probability: The synchronization pattern is, e.g., sent with a symbol mean photon number of μ<1. The quantum channel has losses. E.g., the receiver's detectors may, e.g., have a detection probability of about 80%, and the receiver's detectors may, e.g., have a dead time of ˜10 . . . 10⁵ timebins. Therefore, the synchronization pattern shall be long enough to ensure a high enough detection statistics.

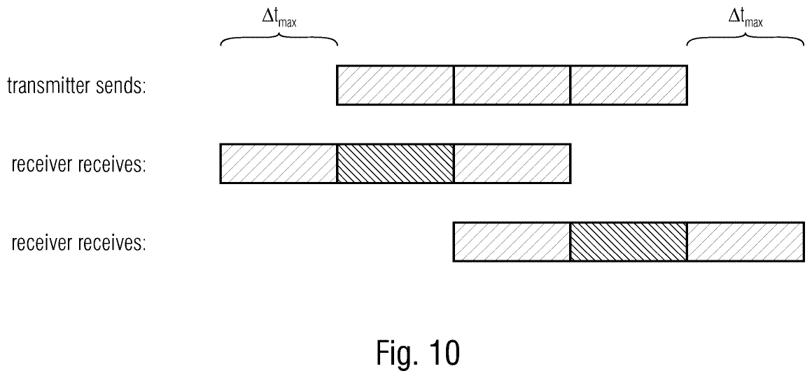

FIG. 10 illustrates two examples for a maximum receiver's clock offset. In the first example (middle line of FIG. 10) the receiver's clock is Δtₘₐₓ behind the transmitter's clock. In the second example (lower line of FIG. 10) the receiver's clock is Δtₘₐₓ ahead of the transmitter's clock.

From FIG. 10, it can be seen that it is useful that the synchronization pattern for each level may, e.g., exhibit a length of 3Δtₘₐₓ. In an embodiment, the receiver may, e.g., take/analyze the middle part and can be sure to get the signals from the right level/group. The synchronization signal may, e.g., be chosen to be longer, if the detection statistics is insufficient.

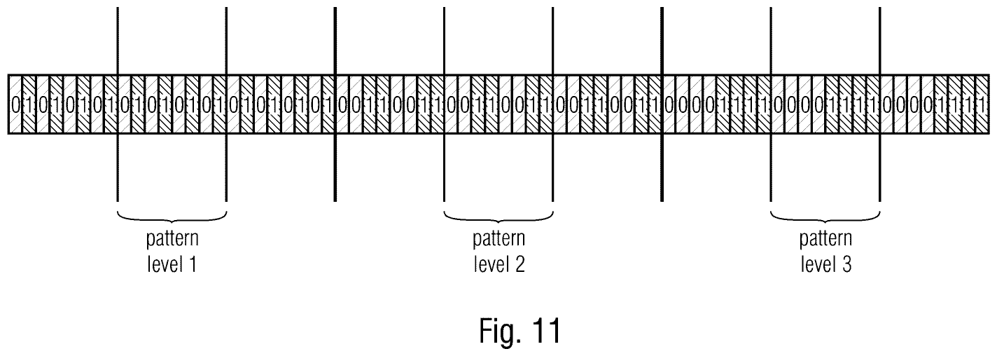

FIG. 11 illustrates a portion of a synchronization pattern according to a particular embodiment. In reality, for example, 100 million symbols may, e.g., be transmitted. FIG. 11 does not show interleaved level patterns of other embodiments.

If the maximum offset is ±m elements, the needed levels is [symbol] =2+┌log₂ m┐, and the duration of one pattern is [symbol] elements. Thus, a total duration: 3× [symbol] × [symbol] elements result.

For an example, where the maximum offset is ±2 elements, the needed levels is [symbol] =2+[log₂ 2]=3, and the duration of one pattern is 2³=8 elements. Thus, a total duration: 3×8×3=72 elements result (for the case of gₚₐᵣₐₗₗₑₗ=1).

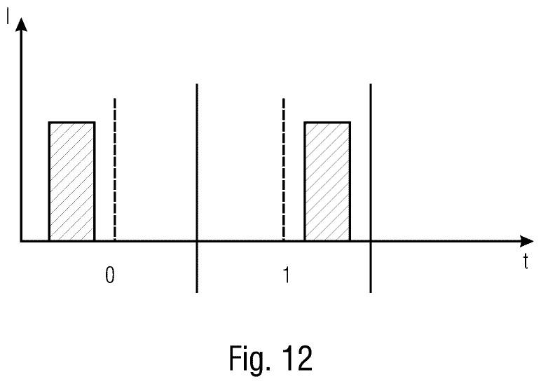

FIG. 12 illustrates a coding of two different symbols, 0 and 1, according to an example. For the symbols 0 and 1, the simples distinguishable patterns may, e.g., be chosen. With a high pulse repetition rate, the detectors are operating in saturation. The detection statistics can be increased by summing all 0 areas for each pattern.

According to an implementation embodiment, arrays of same length for the transmitter and for the receiver may, e.g., be employed. Some embodiments employ a base-2 system, where there are two distinct elements of which all patterns are constructed. Other embodiments may, e.g., employ other base systems, e.g., base-3.

Example for base-3 level patterns:

| Level [symbol] | Level pattern [symbol] | | | | | | | | | |
|---|---|---|---|---|---|---|---|---|---|---|
| Symbol index | \|0 | \|1 | \|2 | \|3 | \|4 | \|5 | \|6 | \|7 | \|8 | \| |
| Symbols for [symbol] = 0 | \|0 | \|0 | \|0 | \|0 | \|0 | \|0 | \|0 | \|0 | \|0 | \| |
| Encoding of [symbol] = 0 | \|P - - | \|P - - | \|P - - | \|P - - | \|P - - | \|P - - | \|P - - | \|P - - | \|P - - | \| |
| Symbols for [symbol] = 1 | \|0 | \|1 | \|2 | \|0 | \|1 | \|2 | \|0 | \|1 | \|2 | \| |
| Encoding of [symbol] = 1 | \|P - - | \|- P - | \|- - P | \|P - - | \|- P - | \|- - P | \|P - - | \|- P - | \|- - P | \| |
| Symbols for [symbol] = 2 | \|0 | \|0 | \|0 | \|1 | \|1 | \|1 | \|3 | \|3 | \|3 | \| |
| Encoding of [symbol] = 2 | \|P - - | \|P - - | \|P - - | \|- P - | \|- P - | \|- P - | \|- - P | \|- - P | \|- - P | \| |

For high clock offsets the counting statistics may, e.g., be higher than needed. Moreover, for high clock offsets, the total synchronization time can probably be reduced by going to a higher base.

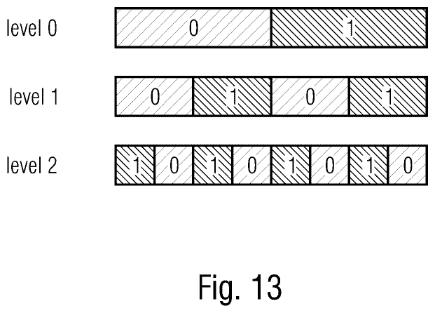

FIG. 13 illustrates the structure of three different level patterns according to an embodiment. Longer areas with the same symbol value depict more symbols with that value within the area.

For example, the first line may, e.g., comprise four 0 values followed by four 1 values; the second line may, e.g., comprise two 0 values, followed by two 1 values, followed by two 0 values, followed by two 1 values; the third line may, e.g., comprise the values 1, 0, 1, 0, 1, 0, 1, 0.

In the following, further embodiments are described.

Inter alia, these embodiments address the problem of synchronization between the transmitter 410 and the receiver 420 in a prepare and measure QKD setup. Several synchronization methods are introduced and compared regarding their transmitted pattern duration, max. detectable clock offset, success probability and computational requirements.

The setup of FIG. 4 may, e.g., be considered, where the transmitter 410 and the receiver 420 may, e.g., be connected via three channels. As already outlined above:

Via the quantum channel 413, pulses (coherent quantum states) with low mean photon number (μ<1) can be sent from the transmitter 410 to the receiver 420. Due to channel losses, the receiver 420 usually receives pulses with μ<<1.

The time is represented by timebins with equal duration. Each timebin can either contain a pulse, or not. A timebin typically has a sub-nanosecond duration, e.g. 800 ps.

Via the clock channel/synchronization channel 412, the transmitter 410 may, e.g., transmit its clock beat to ensure that the receiver 420's clock runs at the correct speed. This channel is assumed to be very stable with regards to the clock phase, so that the receiver 420's clock will jitter by much less than one timebin. This jitter may, e.g., be assumed to be zero.

For the (classical) bi-directional channel 411, high (some milliseconds) unknown and non-deterministic latencies may exist. However, an upper bound for latencies may, e.g., be given/assumed (e.g. some 10 or 100 ms).

After system boot, a clock offset, for example, between the transmitter 410 and the receiver 420 is unknown. Using the classical channel 411, it can be determined up to some coarse precision, typically in the order of some 10 or 100 ms.

The task is now to synchronize the transmitter’ clock and the receiver's clock down to sub-timebin precision (roughly 10% of a timebin). The alignment to sub-timebin precision can, be conducted, e.g., by analyzing a histogram of the received timestamps modulo the timebin duration and shifting the peak to the middle of the timebin.

The proposed concepts achieve a fast synchronization and thus need few resources, e.g., regarding random access memory and computational power. In addition, the needed communication via the classical data channel 411 is reduced to a minimum, because the transmitter 410 may, e.g., only announce once the beginning of the procedure, and because little or no communication at all is needed by the receiver 420.

Currently employed methods may, e.g., need up to 15 to 45 minutes for synchronization, whereas the provided concepts of embodiments achieve synchronization in, e.g., 1 to 5 seconds.

The selection of the level for each state may, e.g., be conducted in any other way. It is advantageous that for each level, the symbols 0 and 1 may, e.g., be transmitted with a probability of around 50%.

According to an embodiment, the transmission of the different levels may, e.g., be conducted sequentially (what would correspond to gₚₐᵣₐₗₗₑₗ=1).

In an embodiment, instead of a binary alphabet, an alphabet with a plurality of symbols may, e.g., be employed.

Moreover, levels may, e.g., be arbitrarily extended by repeating or partially repeating the level pattern.

Application fields of embodiments may, e.g., be the (temporal) synchronization of QKD systems, or, e.g., the (temporal) synchronization of deep space communications systems, or, e.g., the temporal synchronization of communications systems with noisy signals and high channel loss.

Further application fields are LIDAR applications with significantly enhanced duty cycle, wherein reflected or scattered signals being emitted by the transmitter 410 are detected by the receiver 420.

In the following, application examples for LIDAR according to an embodiment are described. Pulsed LIDAR systems typically have a very small duty cycle of far less than 1%. This results from that unique distance determination is only possible for objects, which are closer than

$$d = \frac{c}{2 nR}$$

at the LIDAR system, c indicates the speed of light, wherein n indicates an optical density of the medium (e.g., air, water) and wherein R indicates a repetition rate of the pulsed laser. To increase the maximum distance, the maximum distance rate therefore should be reduced. This needs high requirements regarding the employed laser. Using the synchronization pattern according to embodiments (e.g., with pulse position coding), the laser may, e.g., be operated with a duty cycle of 50%, because the information in the synchronization pattern may, e.g., be used for distance determination. By this, the technical requirements for the employed laser system are significantly reduced.

In the following, an evaluation of some embodiments is presented.

A proper evaluation shall take dark counts, channel transmission, detector efficiency, success probability, pattern duration and computational complexity into account.

Two use cases for the synchronization methods are considered, namely, initial synchronization, performed once at system start which has to detect offsets up to approx. 100 ms; and periodic resynchronization, performed periodically, e.g. once per second, which has to detect offsets up to approx. 1 ms.

The synchronization method should still work properly with SNSPDs in bad conditions (low signal detection rate, high noise detection rate).

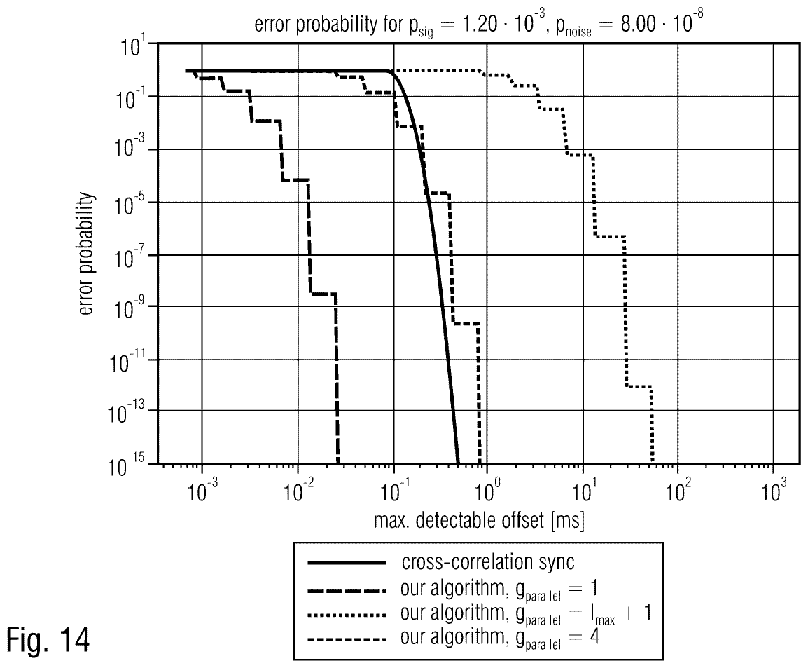

FIG. 14 to FIG. 17 depict evaluation results for a scenario with high signal rates (p_{sig}) and low noise rates (pₙₒᵢₛₑ). In particular:

FIG. 14 illustrates a comparison of error probabilities with respect to a maximum detectable offset for a scenario for different synchronization concepts of some embodiments with high signal rates (p_{sig}) and low noise rates (pₙₒᵢₛₑ).

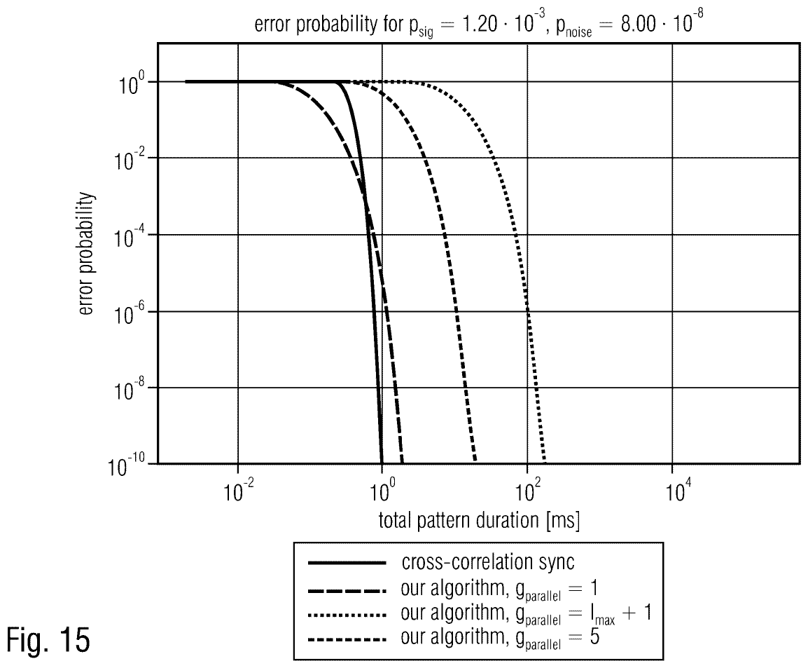

FIG. 15 illustrates a comparison of error probabilities with respect to a total pattern duration for a scenario for different synchronization concepts of some embodiments with high signal rates (p_{sig}) and low noise rates (pₙₒᵢₛₑ).

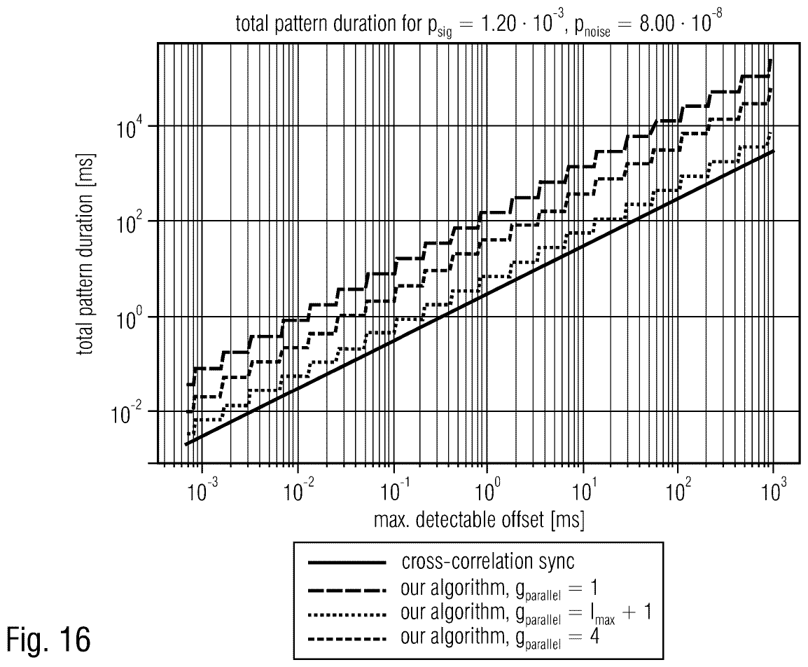

FIG. 16 illustrates a comparison of total pattern durations with respect to a maximum detectable offset for a scenario for different synchronization concepts of some embodiments with high signal rates (p_{sig}) and low noise rates (pₙₒᵢₛₑ).

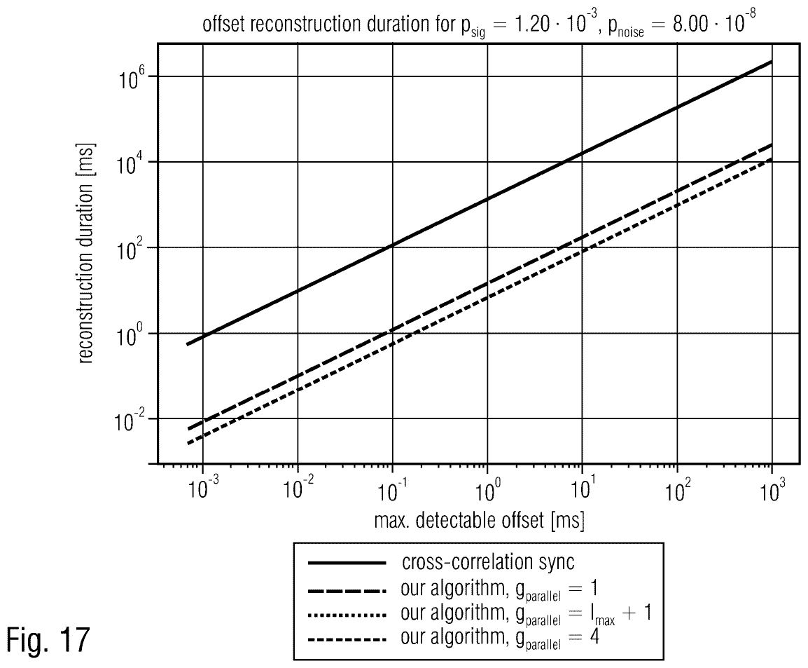

FIG. 17 illustrates a comparison of offset reconstruction durations with respect to a maximum detectable offset for a scenario for different synchronization concepts of some embodiments with high signal rates (p_{sig}) and low noise rates (pₙₒᵢₛₑ).

Considering initial synchronization, as can be seen in FIG. 14 (error probability over max. detectable offset), for a maximum detectable offset of 100 ms, all 3 methods yield reasonable low failure probabilities of less than 1%. Hence, they all qualify.

FIG. 16 (total pattern duration over max. detectable offset) shows, that for a given detectable offset gₚₐᵣₐₗₗₑₗ= [symbol] ₘₐₓ has a slightly higher total pattern duration than Cross-Correlation Sync. This difference is negligible. gₚₐᵣₐₗₗₑₗ=1 has a roughly 15 times higher total pattern duration. For 100 ms max. detectable offset, gₚₐᵣₐₗₗₑₗ= [symbol] ₘₐₓ and Cross-Correlation Sync need a total pattern durations of 300 ms and 600 ms respectively.

As FIG. 17 (reconstruction duration over max. detectable offset) shows, Cross-Correlation Sync has a dramatically higher computational complexity than the method presented here. It would need approx. 100 s for a max. detectable offset of 100 ms, whereas the method described here needs approximately 100 ms on the same hardware.

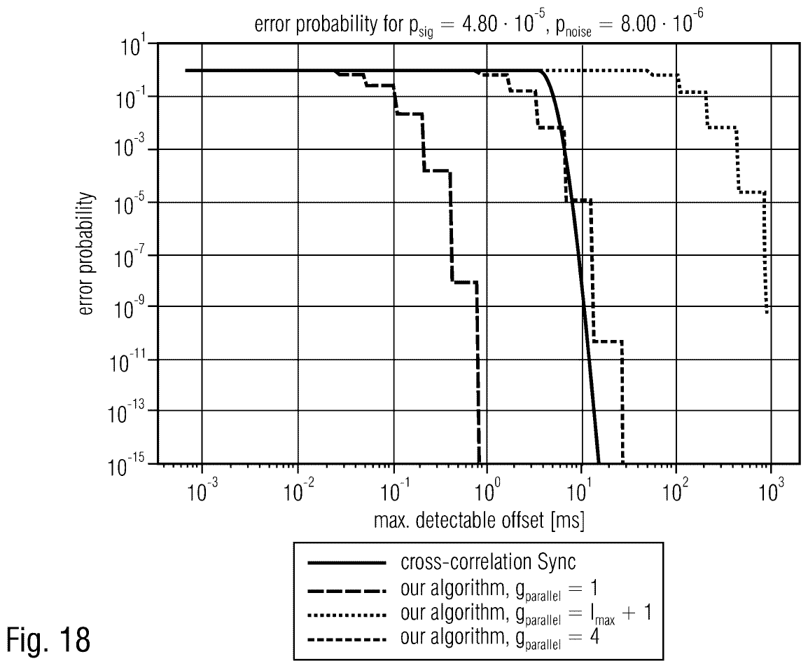

FIG. 18 to FIG. 21 depict evaluation results for a scenario with low signal rates (p_{sig}) and high noise rates (pₙₒᵢₛₑ). In particular:

FIG. 18 illustrates a comparison of error probabilities with respect to a maximum detectable offset for a scenario for different synchronization concepts of some embodiments with low signal rates (p_{sig}) and high noise rates (pₙₒᵢₛₑ).

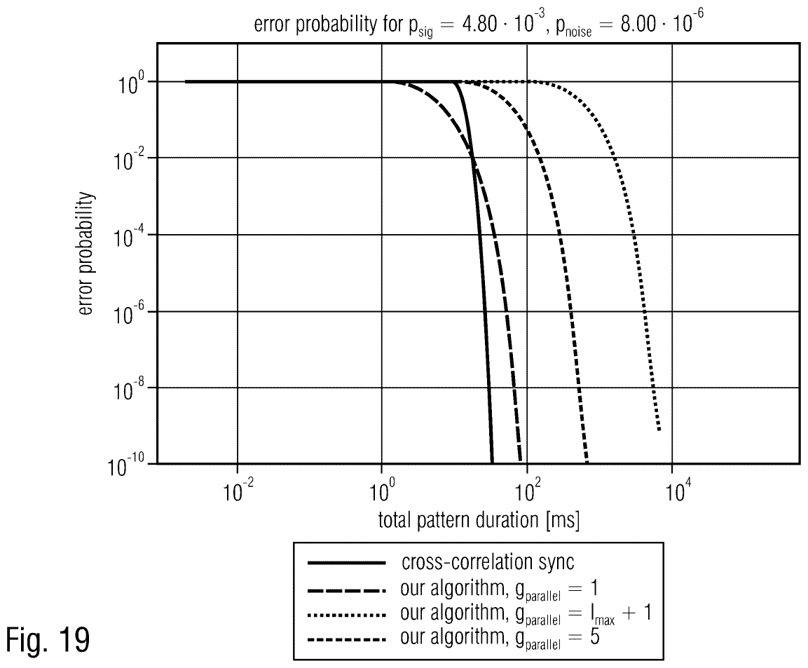

FIG. 19 illustrates a comparison of error probabilities with respect to a total pattern duration for a scenario for different synchronization concepts of some embodiments with low signal rates (p_{sig}) and high noise rates (pₙₒᵢₛₑ).

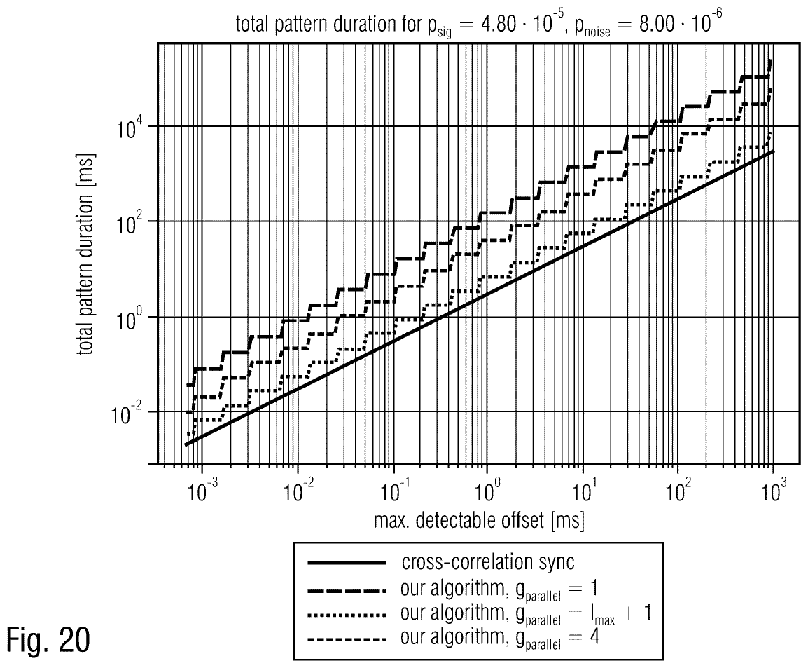

FIG. 20 illustrates a comparison of total pattern durations with respect to a maximum detectable offset for a scenario for different synchronization concepts of some embodiments with low signal rates (p_{sig}) and high noise rates (pₙₒᵢₛₑ).

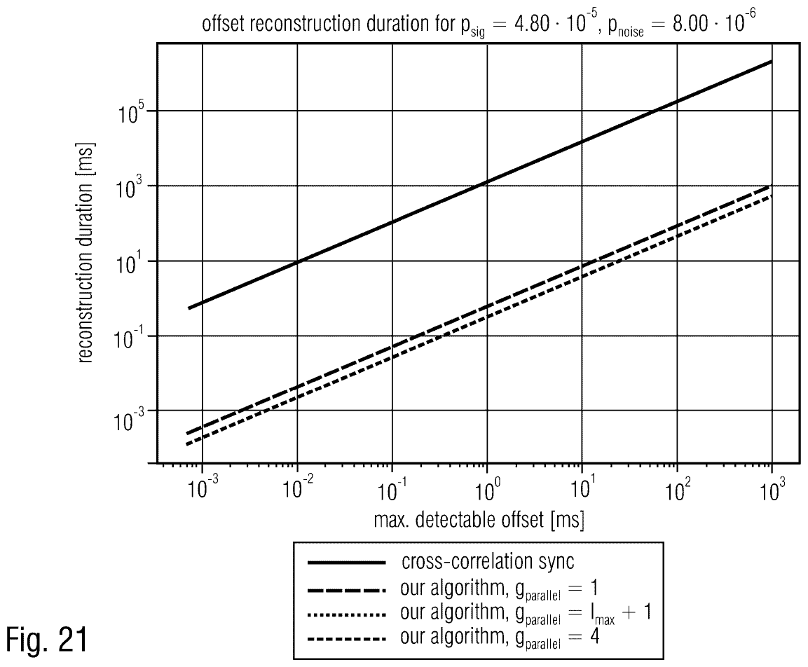

FIG. 21 illustrates a comparison of offset reconstruction durations with respect to a maximum detectable offset for a scenario for different synchronization concepts of some embodiments with low signal rates (p_{sig}) and high noise rates (pₙₒᵢₛₑ).

Considering resynchronization we assume that once per second an offset of max. 1 ms has to be detected. This is a very conservative estimate, since it seems very unlikely that the used clocks will drift as much as 1 ms within one second. Furthermore, we want to restrict the time fraction that is needed for the resynchronization, in order to not reduce the secret key rate too much (no qubits are transmitted during the resynchronization). For the error probability we have higher requirements than for the initial synchronization. Since the resynchronization is repeated once per seconds, its success probability has to be very close to one in order to ensure error-free operation over long periods.

$${( 1 - P ( error ) )}^{n} \geq p ⟺ P ( error ) \leq 1 - {p}^{1 / n} .$$

For example, if we want to have a 90% probability for all resynchronizations during one day to succeed, we need

$$P ( error ) \leq 1 - {0.9}^{24 \cdot 60 \cdot 60} \approx 1.22 \times {10}^{- 6} .$$

For a 99% probability for all resynchronizations during 10 years to succeed, we need

$$P ( error ) \leq 1 - {0.9}^{10 \cdot 365 \cdot 24 \cdot 60 \cdot 60} \approx 3.19 \times {10}^{- 11} .$$

As can be seen in FIG. 19 (error probability over total pattern duration), the method with gₚₐᵣₐₗₗₑₗ= [symbol] ₘₐₓ needs total pattern durations of more than 1000 ms to yield reasonably low error probabilities.

As FIG. 21 (reconstruction duration over max. detectable offset) shows, Cross-Correlation Sync has an unfavorably high computational complexity. However, with approx. 1000 ms it still seems in the range of suitable solutions. Specifically, if we consider that this method can easily be parallelized. The method with gₚₐᵣₐₗₗₑₗ=1 is very favorable regarding the computational complexity.

Looking at the total pattern duration in FIG. 20 (total pattern duration over max. detectable offset) we see that the Cross-Correlation Sync pattern only needs around 3 ms, while the method with gₚₐᵣₐₗₗₑₗ=1 needs approx. 100 ms (reducing the secret key rate by approx. 10%).

Thus, while cross-correlation synchronization may, e.g., be for that scenario be suitable, it might also be a good choice to use the method with gₚₐᵣₐₗₗₑₗ=1, with which one would get much faster computation times, while sacrificing some percent of key rate.

Although some aspects have been described in the context of an apparatus, it is clear that these aspects also represent a description of the corresponding method, where a block or device corresponds to a method step or a feature of a method step. Analogously, aspects described in the context of a method step also represent a description of a corresponding block or item or feature of a corresponding apparatus. Some or all of the method steps may be executed by (or using) a hardware apparatus, like for example, a microprocessor, a programmable computer or an electronic circuit. In some embodiments, one or more of the most important method steps may be executed by such an apparatus.

Depending on certain implementation requirements, embodiments of the invention can be implemented in hardware or in software or at least partially in hardware or at least partially in software. The implementation can be performed using a digital storage medium, for example a floppy disk, a DVD, a Blu-Ray, a CD, a ROM, a PROM, an EPROM, an EEPROM or a FLASH memory, having electronically readable control signals stored thereon, which cooperate (or are capable of cooperating) with a programmable computer system such that the respective method is performed. Therefore, the digital storage medium may be computer readable.

Some embodiments according to the invention comprise a data carrier having electronically readable control signals, which are capable of cooperating with a programmable computer system, such that one of the methods described herein is performed.

Generally, embodiments of the present invention can be implemented as a computer program product with a program code, the program code being operative for performing one of the methods when the computer program product runs on a computer. The program code may for example be stored on a machine readable carrier.

Other embodiments comprise the computer program for performing one of the methods described herein, stored on a machine readable carrier.

In other words, an embodiment of the inventive method is, therefore, a computer program having a program code for performing one of the methods described herein, when the computer program runs on a computer.

A further embodiment of the inventive methods is, therefore, a data carrier (or a digital storage medium, or a computer-readable medium) comprising, recorded thereon, the computer program for performing one of the methods described herein. The data carrier, the digital storage medium or the recorded medium are typically tangible and/or non-transitory.

A further embodiment of the inventive method is, therefore, a data stream or a sequence of signals representing the computer program for performing one of the methods described herein. The data stream or the sequence of signals may for example be configured to be transferred via a data communication connection, for example via the Internet.

A further embodiment comprises a processing means, for example a computer, or a programmable logic device, configured to or adapted to perform one of the methods described herein.

A further embodiment comprises a computer having installed thereon the computer program for performing one of the methods described herein.

A further embodiment according to the invention comprises an apparatus or a system configured to transfer (for example, electronically or optically) a computer program for performing one of the methods described herein to a receiver. The receiver may, for example, be a computer, a mobile device, a memory device or the like. The apparatus or system may, for example, comprise a file server for transferring the computer program to the receiver.

In some embodiments, a programmable logic device (for example a field programmable gate array) may be used to perform some or all of the functionalities of the methods described herein. In some embodiments, a field programmable gate array may cooperate with a microprocessor in order to perform one of the methods described herein. Generally, the methods are performed by any hardware apparatus.

The apparatus described herein may be implemented using a hardware apparatus, or using a computer, or using a combination of a hardware apparatus and a computer.

The methods described herein may be performed using a hardware apparatus, or using a computer, or using a combination of a hardware apparatus and a computer.

While this invention has been described in terms of several advantageous embodiments, there are alterations, permutations, and equivalents, which fall within the scope of this invention. It should also be noted that there are many alternative ways of implementing the methods and compositions of the present invention. It is therefore intended that the following appended claims be interpreted as including all such alterations, permutations, and equivalents as fall within the true spirit and scope of the present invention.

### REFERENCES

[1] US 2012/0177200 A1, K. Harrison, W. Munro, “Quantum Key Distribution Method and Apparatus”.
[2] US 2017/0230174 A1, J. Choi, “Method and Device for Synchronizing Quantum Data Start Points in Quantum Key Distribution System”.
[3] WO 2020/254087 A1, M. Braithwaite, “Quantum Channel Synchronization”.
[4] Luca Calderaro, Andrea Stanco, Costantino Agnesi, Marco Avesani, Daniele Dequal, Paolo Villoresi, and Giuseppe Vallone, “Fast and Simple Qubit-Based Synchronization for Quantum Key Distribution”, in Phys. Rev. Applied 13, 054041, published 18 May 2020.

1. An apparatus for synchronization by determining a clock offset between a current receiver clock time and a correct receiver clock time, wherein the apparatus comprises:
an input interface for receiving information on a received synchronization sequence comprising a sequence of symbols, wherein the information on the received synchronization sequence comprises information for each symbol of a plurality of symbols of the sequence of symbols that said symbol exhibits a first state out of two or more possible states being different from a second state of the two possible states; and
an offset analyser for determining the clock offset by determining an analysis result for each of a plurality of levels depending on the received synchronization sequence and depending on a level pattern being associated with said level, and by determining the clock offset using the analysis result of each of the plurality of levels, wherein the level pattern for each of the plurality of levels comprises a sequence of symbols and is different from any other level pattern of the plurality of levels.

2. An apparatus according to claim 1,
wherein the input interface is configured to receive the received synchronization sequence from another apparatus, and
wherein, for the synchronization, the apparatus is configured to not transmit any message to said other apparatus.

3. An apparatus according to claim 1,
wherein each symbol of the sequence of symbols of the synchronization sequence is randomly or pseudo-randomly associated with a level out of the plurality of levels such that the state of said symbol of the sequence of symbols corresponds to a state of a symbol of the level pattern being associated with said level.

4. An apparatus according to claim 1,
wherein the synchronization sequence that is received as the received synchronization sequence has been generated such that the synchronization sequence comprises symbols of the level pattern of each level of the plurality of levels, wherein each symbol of the symbols of said level pattern is encoded by the state of one or more symbols of the sequence of symbols of the synchronization sequence,
wherein the synchronization sequence has been generated such that for each symbol position in the synchronization sequence, the level pattern of one of the plurality of levels has been chosen for determining a symbol for said symbol position in the synchronization sequence, such that the symbols of different level patterns are mixed within the synchronization sequence, such that the synchronization sequence does not comprise the symbols of a level pattern of one of the plurality of levels in a correct order.

5. An apparatus according to claim 1,
wherein a first one of the symbols of the synchronization sequence exhibits a state that corresponds to the state of a symbol of the level pattern being associated with a first level out of the plurality of levels,
wherein a second one of the symbols of the synchronization sequence, which immediately succeeds the first one of the symbols within the synchronization sequence, exhibits a state that corresponds to the state of a symbol of the level pattern being associated with a second level out of the plurality of levels, the second level being different from the first level, and
wherein a third one of the symbols of the synchronization sequence, which immediately succeeds the second one of the symbols within the synchronization sequence, exhibits a state that corresponds to the state of a symbol of the level pattern being associated with a third level out of the plurality of levels, the third level being different from the second level.

6. An apparatus according to claim 1,
wherein the synchronization sequence that is received as the received synchronization sequence has been generated such that it comprises one or more occurrences of the level pattern of each level of the plurality of levels in a correct order.

7. An apparatus according to claim 1,
wherein the offset analyser is configured to determine the analysis result for each level [symbol] of the plurality of levels by determining for said level, whether or not the offset exhibits at least [symbol] ⁻¹ time units, wherein a time unit is equal to a duration of a symbol of the sequence of symbols, or is equal to a positive multiple m of the duration of a symbol of the sequence of symbols, wherein the level [symbol] is an integer value with [symbol] ≥0 for each of the plurality of levels, wherein m is a real value with m>0.

8. An apparatus according to claim 7,
wherein the offset analyser is configured to determine a level offset for each level [symbol] of the plurality of levels, such that the level offset for said level [symbol] is either [symbol] ⁻¹ time units or is 0;
wherein the clock offset corresponds to a sum of the level offset of each level [symbol] of the plurality of levels, or corresponds to a difference of the sum and [symbol] ^{max}, or corresponds to an integer multiple of said sum or of said difference, or corresponds to said sum or of said difference divided by a predefined value.

9. An apparatus according to claim 8,
wherein the offset analyser is configured to determine for each level of the plurality of levels and a comparison result for each symbol of at least a portion of the plurality of symbols, which exhibits the first state, whether a symbol at a corresponding position in the level pattern of the said level exhibits the first state or exhibits the second state,
wherein the offset analyser is configured to determine the level offset such that the level offset is 0, if for said level more comparison results have been determined where the compared symbols exhibit a same state compared to comparison results for said level where the compared symbols exhibit a different state, and
wherein the offset analyser is configured to determine the level offset such that the level offset exhibits [symbol] ⁻¹ time units, if for said level more comparison results or a same number of comparison results have been determined where the compared symbols exhibit a different state compared to comparison results for said level where the compared symbols exhibit the same state.

10. An apparatus according to claim 9,
wherein the level offset for each level is determined subsequently starting from a smallest level among the plurality of levels.

11. An apparatus according to claim 10,
wherein, if the offset analyser has determined for a level of the plurality of levels that a level offset exhibits [symbol] ⁻¹ time units, the plurality of symbols of the received synchronization sequence are shifted by the level offset for said level before determining the level offset for a subsequent level of the plurality of levels.

12. An apparatus for generating a synchronization sequence for synchronization, wherein the apparatus comprises:
a synchronization sequence generator for generating, using a plurality of level patterns, the synchronization sequence comprising a sequence of symbols, and
an output interface for outputting or transmitting the synchronization sequence,
wherein the level pattern of each of the plurality of level patterns comprises a sequence of symbols, wherein each of the plurality of symbols of each of the plurality of level patterns exhibits a state out of two or more possible states, wherein the level pattern of each of the plurality of level patterns is different from any other level pattern of the plurality of level pattern,
wherein the synchronization sequence generator is configured to generate the synchronization sequence by assigning, to each symbol of the sequence of symbols of the synchronization sequence, the state of one of the plurality of symbols of one of the plurality of level patterns.

13. An apparatus according to claim 12,
wherein the apparatus is configured to transmit the synchronization sequence to a further apparatus, and
wherein, for the synchronization, the apparatus is configured to not receive any message from said further apparatus.

14. An apparatus according to claim 12,
wherein the synchronization sequence generator is configured to select, for each symbol of the sequence of symbols of the synchronization sequence, a level out of the plurality of levels, and
wherein the synchronization sequence generator is configured to assign a symbol of the plurality of symbols of the level pattern associated with said level to said symbol of the sequence of symbols of the synchronization sequence.

15. An apparatus according to claim 14,
wherein the synchronization sequence generator is configured to select, for each symbol of the sequence of symbols of the synchronization sequence, the level out of the plurality of levels, randomly or pseudo-randomly.

16. An apparatus according to claim 12,
wherein the synchronization sequence generator is configured to generate the synchronization sequence such that the synchronization sequence comprises symbols of the level pattern of each level of the plurality of levels,
wherein the synchronization sequence generator is configured to generate the synchronization sequence such that for each symbol position in the synchronization sequence, the level pattern of one of the plurality of levels is chosen for determining a symbol for said symbol position in the synchronization sequence, such that the symbols of different level patterns are mixed within the synchronization sequence, such that the synchronization sequence does not comprise the symbols of a level pattern of one of the plurality of levels in a correct order.

17. An apparatus according to claim 12,
wherein each level out of the plurality of levels belongs to a group out of one or more groups,
wherein the synchronization sequence generator is configured to select, for a symbol of the sequence of symbols of the synchronization sequence, a level out of a current group out of the one or more groups, and
wherein the synchronization sequence generator is configured to assign a symbol of the plurality of symbols of the level pattern associated with said level to said symbol of the sequence of symbols of the synchronization sequence.

18. An apparatus according to claim 12,
wherein the synchronization sequence generator is configured to generate the synchronization sequence such that it comprises one or more occurrences of the level pattern of each level of the plurality of levels in a correct order.

19. An apparatus according to claim 12,
wherein the synchronization sequence generator is configured to assign a symbol of the plurality of symbols of the level pattern associated with a first level of out the plurality of levels to a first one of the symbols of the synchronization sequence,
wherein the synchronization sequence generator is configured to assign a symbol of the plurality of symbols of the level pattern associated with a second level of out the plurality of levels to a second one of the symbols of the synchronization sequence, the second one of the symbols of the synchronization sequence being an immediate successor of the first one of the symbols of the synchronization sequence, the second level being different from the first level, and
wherein the synchronization sequence generator is configured to assign a symbol of the plurality of symbols of the level pattern associated with a third level of out the plurality of levels to a third one of the symbols of the synchronization sequence, the third one of the symbols of the synchronization sequence being an immediate successor of the second one of the symbols of the synchronization sequence, the third level being different from the second level.

20. An apparatus according to claim 12,
wherein each symbol of the plurality of symbols of the level pattern of each level either exhibits a first bit value out of two possible bit values or a second bit value out of the two possible bit values,
wherein each of the plurality of symbols of said level pattern is encoded by a state of one or more symbols of the plurality of symbols of the level pattern,
wherein the synchronization sequence comprises a sequence of symbols, wherein each of the sequence of symbols of the synchronization sequence is encoded by a state of one or more symbols of the sequence of symbols of the synchronization sequence,
wherein the synchronization sequence generator is configured to generate the sequence of symbols of the synchronization sequence by assigning one of the plurality of symbols of the level pattern of a level as a symbol of the synchronization sequence for each of the sequence of symbols of the synchronization sequence.

21. An apparatus according to claim 20,
wherein the level pattern for each level [symbol] of the plurality of levels comprises a first sequence of c× [symbol] ⁻¹ symbols which exhibit the first bit value, immediately followed by a second sequence of symbols which exhibit the second bit value; or wherein the level pattern for each level [symbol] of the plurality of levels comprises the second sequence of c× [symbol] ⁻¹ symbols which exhibit the second bit value, immediately followed by the first sequence of c× [symbol] ⁻¹ symbols which exhibit the first bit value, wherein c is a real positive value.

22. A system comprising:
an apparatus according to claim 12 for generating a synchronization sequence for synchronization, and
an apparatus according to claim 1 for synchronization by determining a clock offset,
wherein the input interface of the apparatus for synchronization by determining the clock offset is configured to receive the received synchronization sequence, or a part of it, being generated by the apparatus for generating the synchronization sequence, and
wherein the offset analyser of the apparatus for synchronization by determining the clock offset is configured to determine the clock offset by determining the analysis result for each of the plurality of levels depending on the received synchronization sequence and depending on the level pattern being associated with said level, and by determining the clock offset using the analysis result of each of the plurality of levels.

23. A system according to claim 22,
wherein the system comprises one or more further apparatuses according to claim 1 for synchronization by determining a clock offset,
wherein the input interface of each of the further apparatuses for synchronization by determining the clock offset is configured to receive the received synchronization sequence being generated by the apparatus for generating the synchronization sequence, and
wherein the offset analyser of each of the further apparatuses for synchronization by determining the clock offset is configured to determine the clock offset by determining the analysis result for each of the plurality of levels depending on the received synchronization sequence and depending on the level pattern being associated with said level, and by determining the clock offset using the analysis result of each of the plurality of levels.

24. A method for synchronization by determining a clock offset between a current receiver clock time and a correct receiver clock time, wherein the method comprises:
receiving information on a received synchronization sequence comprising a sequence of symbols, wherein the information on the received synchronization sequence comprises information for each symbol of a plurality of symbols of the sequence of symbols that said symbol exhibits a first state out of two or more possible states being different from a second state of the two possible states; and
determining the clock offset by determining an analysis result for each of a plurality of levels depending on the received synchronization sequence and depending on a level pattern being associated with said level, and by determining the clock offset using the analysis result of each of the plurality of levels, wherein the level pattern for each of the plurality of levels comprises a sequence of symbols and is different from any other level pattern of the plurality of levels.

25. A method for generating a synchronization sequence for synchronization, wherein the method comprises:
generating, using a plurality of level patterns, the synchronization sequence comprising a sequence of symbols, and
outputting or transmitting the synchronization sequence,
wherein the level pattern of each of the plurality of level patterns comprises a sequence of symbols, wherein each of the plurality of symbols of each of the plurality of level patterns exhibits a state out of two or more possible states, wherein the level pattern of each of the plurality of level patterns is different from any other level pattern of the plurality of level pattern,
wherein generating the synchronization sequence comprises assigning, to each symbol of the sequence of symbols of the synchronization sequence, the state of one of the plurality of symbols of one of the plurality of level patterns.

26. A non-transitory digital storage medium having a computer program stored thereon to perform the method for synchronization by determining a clock offset between a current receiver clock time and a correct receiver clock time, wherein the method comprises:
receiving information on a received synchronization sequence comprising a sequence of symbols, wherein the information on the received synchronization sequence comprises information for each symbol of a plurality of symbols of the sequence of symbols that said symbol exhibits a first state out of two or more possible states being different from a second state of the two possible states; and
determining the clock offset by determining an analysis result for each of a plurality of levels depending on the received synchronization sequence and depending on a level pattern being associated with said level, and by determining the clock offset using the analysis result of each of the plurality of levels, wherein the level pattern for each of the plurality of levels comprises a sequence of symbols and is different from any other level pattern of the plurality of levels,
when said computer program is run by a computer.

27. A non-transitory digital storage medium having a computer program stored thereon to perform the method for generating a synchronization sequence for synchronization, wherein the method comprises:
generating, using a plurality of level patterns, the synchronization sequence comprising a sequence of symbols, and
outputting or transmitting the synchronization sequence,
wherein the level pattern of each of the plurality of level patterns comprises a sequence of symbols, wherein each of the plurality of symbols of each of the plurality of level patterns exhibits a state out of two or more possible states, wherein the level pattern of each of the plurality of level patterns is different from any other level pattern of the plurality of level pattern,
wherein generating the synchronization sequence comprises assigning, to each symbol of the sequence of symbols of the synchronization sequence, the state of one of the plurality of symbols of one of the plurality of level patterns,
when said computer program is run by a computer.
